(19) United States
(12) Patent Application Publication
(10) Pub. No.: US 2022/0245146 A1
(43) Pub. Date: Aug. 4, 2022

(54) SYSTEMS, METHODS, AND APPARATUSES FOR IMPLEMENTING OFF-STACK BATCH QUERYING FOR VIRTUAL ENTITIES USING A BULK API

(71) Applicant: salesforce.com, inc., San Francisco, CA (US)

(72) Inventors: Christopher Mimms, San Francisco, CA (US); Nick Hunt, San Francisco, CA (US); Marcus Moncayo, San Francisco, CA (US); Matt Moldavan, San Francisco, CA (US); Yiping Wolgemuth, San Francisco, CA (US); Danielle Grau, San Francisco, CA (US)

(21) Appl. No.: 17/163,446

(22) Filed: Jan. 30, 2021

(51) Int. Cl. G06F 16/2453; G06F 9/54; H04L 29/06; G06F 16/9535; G06F 21/62; G06F 16/2455

(52) U.S. Cl. CPC G06F 16/24535; G06F 9/541; H04L 63/102; G06F 16/24532; G06F 21/6227; G06F 16/24556; G06F 16/9535

(57) ABSTRACT

Systems, methods, and apparatuses for implementing off-stack batch querying for virtual entities using a bulk API within a cloud based computing environment are disclosed. According to an exemplary embodiment, there is a system having at least a processor and a memory therein, wherein the system includes means for interfacing with a multi-tenant database system within the host organization having information stored on behalf of a plurality of customer organizations; receiving a query at the host organization requesting retrieval of data stored on behalf of one of the plurality of customer organizations identified by an OrgID unique to the one respective customer organization; determining the data resides within an external cloud platform; performing an account multiplexer operation to identify multiple accounts at the external cloud platform based on both (i) a known association between OrgID and the multiple accounts at the external cloud platform and (ii) availability of known access credentials for the multiple accounts at the external cloud platform being accessible to the one customer organization identified by the OrgID; breaking up the query into multiple sub-queries, each targeting a distinct one of the multiple accounts at the external cloud platform; issuing the multiple sub-queries to the external cloud platform using the known access credentials for the multiple accounts; receiving multiple data sets responsive to the multiple sub-queries issued to the external cloud platform; aggregating the multiple data sets into an aggregated master data set in fulfillment of the query received; and storing the aggregated master data set temporarily within the multi-tenant database system of the host organization. Other related embodiments are disclosed.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments disclosed herein relate generally to the field of computing, and more particularly, to systems, methods, and apparatuses for implementing off-stack batch querying for virtual entities using a bulk API within a cloud based computing environment such as a database system implementation supported by a processor and a memory to execute such functionality. Such means may be implemented within the computing architecture of a hosted computing environment, such as an on-demand or cloud-computing environment that utilizes multi-tenant database technologies, client-server technologies, traditional database technologies, or other computing architecture in support of the hosted computing environment.

### BACKGROUND

The subject matter discussed in this background section should not necessarily be construed as prior art merely because of its mention in this section. Similarly, a problem mentioned in this section or associated with the subject matter of this section should not be construed as being previously recognized in the prior art. The subject matter in this section merely represents different approaches, which in and of themselves may also correspond to claimed embodiments.

Pardot is a Software as a Service (SaaS) marketing automation platform provided by SalesForce which offers email automation, targeted email campaigns, and lead management for B2B sales and marketing organizations.

The Pardot automation platform creates a very large amount of data on behalf of the cloud computing customers utilizing the platform which can result in both a richness of data which is highly beneficial to the customer but additionally introduces technical problems and complexity related to the integration of such data into the Salesforce.com ecosystem when operating at scale.

For instance, the Pardot automation platform captures and records millions of engagement activities for customers of the cloud computing platform to help such customers track prospect interactions, such as when a prospect opens a marketing email, when a prospect visits a campaign landing page, and so forth. Such prospect interactions are of the utmost importance to marketers who will later seek to analyze the effect of their marketing campaigns.

Such cloud computing customers, also referred to as “tenants,” expect a cohesive, integrated, and highly intuitive user experience within the core SalesForce applications and functions, such as reporting, querying, navigation, etc., many of which require the ability to quickly surface data within such SalesForce applications.

Unfortunately, there is presently no mechanism by which to centrally display and surface marketing activity data for customers utilizing both the Pardot automation platform as well as the core SalesForce applications and functions.

Problematically, due to the sheer volume of data tracked by the Pardot automation platform, including the millions of tracked engagement activities by customers, it simply is not practical to copy, move, or relocate the Pardot data into the underlying data storage utilized by the core SalesForce applications, such as the CRM platform, as doing so has been shown to have a degradation effect upon the core SalesForce applications' respective database systems as well as responsiveness of the core SalesForce applications and supporting analytics due to the creation of so many additional records within the core SalesForce applications at the scale which the core SalesForce applications and Pardot automation platforms operate.

Similarly, it is not feasible or desirable to relocate, move, or copy the databases utilized by the core SalesForce applications into the underlying data storage utilized by the Pardot automation platform as doing so will degrade both the Pardot automation platform and the core SalesForce applications, leading to an unsatisfactory customer experience by users of both platforms.

Notwithstanding these technical challenges, customers of the cloud computing platform have requested an intuitive and simple to use mechanism by which to surface information from the Pardot automation platform within any of the core SalesForce applications, even when the underlying data originates from the Pardot automation platform or for which master and authoritative copy of such data resides within the Pardot automation platform.

A solution to the problem is therefore necessitated by customer demand and in fulfillment of customer expectations for a fully integrated user experience of all data accessible to the customer, without regard to the “origination point” of such data.

The state of the art may therefore benefit from the systems, methods, and apparatuses for implementing off-stack batch querying for virtual entities using a bulk API within a cloud based computing environment, as described herein.

### BRIEF DESCRIPTION OF THE DRAWINGS

Embodiments are illustrated by way of example, and not by way of limitation, and will be more fully understood with reference to the following detailed description when considered in connection with the figures in which:

FIG. 1 depicts an exemplary architecture of a cloud computing environment in accordance with described embodiments;

FIG. 2 depicts a flow diagram illustrating an exemplary bulk API flow in accordance with described embodiments;

FIG. 3 depicts another flow diagram illustrating an improved bulk API flow with Virtual Entity chunking, in accordance with described embodiments;

FIG. 4 depicts data flow through an account multi-plexer, in accordance with described embodiments;

FIG. 5 depicts the source and return flow of externally stored marketing data, in accordance with described embodiments;

FIG. 6 depicts another exemplary architecture depicting the data flows making externally stored data accessible to an analytics engine, in accordance with described embodiments;

FIG. 7 depicts an exemplary Graphical User Interface (GUI) concurrently displaying both internal host organization data with external cloud platform data, in accordance with described embodiments;

FIGS. 8A and 8B depict a flow diagram illustrating a method for implementing off-stack batch querying for virtual entities using a bulk API within a cloud based computing environment; in accordance with described embodiments;

FIG. 9A illustrates a block diagram of an environment 998 in which an on-demand database service may operate in accordance with the described embodiments;

FIG. 9B illustrates another block diagram of an embodiment of elements of FIG. 9A and various possible interconnections between such elements in accordance with the described embodiments; and

FIG. 10 illustrates a diagrammatic representation of a machine in the exemplary form of a computer system, in accordance with one embodiment.

### DETAILED DESCRIPTION

Described herein are systems, methods, and apparatuses for implementing off-stack batch querying for virtual entities using a bulk API within a cloud based computing environment. According to an exemplary embodiment, there is a system having at least a processor and a memory therein, wherein the system includes means for interfacing with a multi-tenant database system within the host organization having information stored on behalf of a plurality of customer organizations; receiving a query at the host organization requesting retrieval of data stored on behalf of one of the plurality of customer organizations identified by an OrgID unique to the one respective customer organization; determining the data resides within an external cloud platform; performing an account multiplexer operation to identify multiple accounts at the external cloud platform based on both (i) a known association between OrgID and the multiple accounts at the external cloud platform and (ii) availability of known access credentials for the multiple accounts at the external cloud platform being accessible to the one customer organization identified by the OrgID; breaking up the query into multiple sub-queries, each targeting a distinct one of the multiple accounts at the external cloud platform; issuing the multiple sub-queries to the external cloud platform using the known access credentials for the multiple accounts; receiving multiple data sets responsive to the multiple sub-queries issued to the external cloud platform; aggregating the multiple data sets into an aggregated master data set in fulfillment of the query received; and storing the aggregated master data set temporarily within the multi-tenant database system of the host organization.

As noted above, tenants or cloud computing customers utilizing services provided by a host organization, such as SalesForce, expect a cohesive, integrated, and highly intuitive user experience regardless of whether they are utilizing core SalesForce applications and functions (e.g., querying, reporting, navigation, etc.) or supplementary services and functions, such as CRM based functions provided by either the SalesForce CRM platform or those provided by through the Pardot automation platform.

The Pardot automation platform creates a very large amount of data on behalf of the cloud computing customers utilizing the platform which can result in both a richness of data which is highly beneficial to the customer but additionally introduces technical problems and complexity related to the integration of such data into the SalesForce ecosystem when operating at scale.

Unfortunately, due to the size and scale of the dataset managed by the Pardot automation platform, integration of the dataset into the core suite of functionality provided by the SalesForce host organization, including integration with the core applications and the underlying multi-tenant database environment upon which the host organization operates, is not a simple matter. For instance, two solutions that may be considered are to simply copy or replicate the entire Pardot automation platform dataset into the multi-tenant database environment of the host organization upon which the core SalesForce applications are built and operate, and then simply query to, or reference, the information stored within the replicated dataset, as needed. A second possible solution is to implement a simple API to query, in real-time, the dataset located within the Pardot automation platform from within any core application provided by the host organization, such as the SalesForce CRM platform, in the event that the application provided by the host organization requires data from the separately managed Pardot automation platform.

Unfortunately, both of these approaches have been demonstrated to be either technically infeasible or unsatisfactory from a customer usage perspective. Not only does replication of the Pardot automation platform dataset into the multi-tenant database system in its current form results in decreased performance, but there is also a further technical barrier which arises due to the fact that the Pardot automation platform dataset requires some additional restructuring. This restructuring issue further complicates any replication efforts, thus resulting in a “copy” of the original dataset which no longer matches the original, and thus, presents significant and unacceptable challenges with respect to maintenance and synchronization of the replicated and modified dataset. With respect to the second possible approach, utilization of a simple real-time API to query data on an as-needed basis from the Pardot automation platform into the host organization's applications results in an unacceptable amount of latency when surfacing information to such applications operating within the host organization's suite of functionality, which exposes users to a sub-optimal experience due to the perceived delay or “hanging” of the user interface.

Furthermore, the difficulty with presenting a cohesive user experience is not limited strictly to the Pardot automation platform dataset. Rather, the problem arises for any platform having data stored externally from the multi-tenant database environment of the host organization from which functionality and applications of the host organization must retrieve and surface information to end users.

In particular, the user experience of cloud computing customers becomes fragmented when data is stored external to the host organization's multi-tenant database environment and is then retrieved from that external environment utilizing conventional real-time APIs. For example, not only are users likely to perceive the latency delay attributable to the retrieval of externally stored data but additionally, supporting applications such as analytics must either trigger a significant number of queries to the external data source to fulfill the analytical specifications for the dataset or alternatively, the analytics engine must cumbersomely and unnecessarily replicate sub-portions of the external dataset which then presents stale and out-dated results in the event of out-of-synch (e.g., not live) data is utilized by the analytics engine or the conventionally known replication techniques tends to create unacceptable levels of overhead as data is copied and updated with greater frequency so as to minimize synchronization problems.

More particularly, the synching of such data may involve hundreds of millions of data records per organization customer organization, of which there are many thousands, each having non-uniformly sized datasets. Thus, processing of such externally stored data using prior known techniques may necessitate an unacceptable burden to be placed upon customer organizations that must rely upon data translators customized for a specific third-party Application Programming Interface (API).

Complicating this issue even further is the fact that a single customer organization or tenant having data stored within the multi-tenant database of the host organization may have multiple different accounts on external platforms where stored data exists, making identifying and recalling data from these accounts difficult due to the one-to-many relationship between the single account at the host organization and the multiple accounts at the external platform. The problem of presenting a unified customer experience via a single platform is thus further compounded as the external platform hosts data on behalf of multiple disparate companies and entities with separate and distinct data sources and external data stacks.

Utilizing traditional Virtual Entities, which serve as a proxy for data stored outside of a platform, similarly does not provide an adequate solution to this problem. Standard usage of such Virtual Entities is optimized for synchronous real-time data access on a much smaller scale, such as updating and accessing related lists within a detail page in the context of a single request made via a user interface that surfaces less than, for example, approximately 1,000 records. Thus, while sending API calls via a Virtual Entity to an external stack may be technically feasible for surfacing data at a smaller scale, it is not suitable for large queries or for queries to datasets having hundreds of millions of records.

A better solution was therefore sought after and ultimately conceived of through the use of the so-called “off-stack” batch querying functionality for virtual entities using a bulk API.

In a continued effort to move toward a single unified customer experience, many off-core services available via the host organization, including the Pardot automation platform which stores its data externally from the multi-tenant database system of the host organization, are building products that require surfacing large amounts of data within the core services, specifically, from within those core services which expose applications and functionality to customers that are operating upon the host organization's multi-tenant database system. The complexities relating to this issue are further compounded as SalesForce continues to acquire other companies, each having their own technical configuration and specification for the external functional stacks and associated external data sources, all of which must then be unified within a cohesive and uniform customer experience (e.g., via UX on the host organization side), such that data retrieved from external sources may nevertheless appear to the customer as though they are operating from within one platform, when in reality they are not.

With respect to the Pardot automation platform specifically, embodiments described herein enable the Pardot automation platform to provide customers with both Marketing data (from the external Pardot data set) as well as Sales data (from the core services of the host organization's operating upon the multi-tenant database system environment) together as a seamless experience in with respect to Analytics.

In support of such a solution, Virtual Entities are therefore enhanced to purposefully extend the capability of the framework so as to accommodate the massive scale of the externally stored Pardot automation platform data or any externally stored data repository at volume.

This is accomplished through the utilization of a novel mechanism that provides off-core primary key (PK) chunking. According to certain embodiments, this functionality is specifically integrated to be compatible with the core bulk API's high throughput framework so that it may seamlessly co-exist with existing core bulk API usage patterns. Many existing services, including the Analytics ETL processes, already consume the Bulk API, and as such, further modification to the core bulk API is not required to support the new off-core primary key chunking capability.

According to a particular embodiment, the high throughput framework job processor intercepts incoming server-side primary key chunking requests, bypasses the core API's primary key Oracle chunking logic, and then passes the chunking responsibility off to a Bulk API operating at the externally stored data repository, such as a Pardot specific Bulk API operating at the Pardot automation platform.

The external platform then proceeds to chunk (e.g., fragment or “breakup”) the request by time frame, potentially with additional optional filters, so as to efficiently query the data and to retrieve the necessary information out of the external platform's data stack, and then return the query results to the Core bulk API operating within the host organization.

From the perspective of the application or function within the host organization that is querying the Core bulk query API and consuming returned data from the Core bulk API, the entire operation appears no different than a typical server side primary key chunking request using a server primary key chunking http request header. Therefore, the application or function making the call is not required alter its behavior so as to accommodate the call for external data. Additionally, the new model provides the final piece of the puzzle which is required for building Virtual Entity BPOs that are at parity with standard, on-stack Business Process Outsourcing (BPOs) objects, thus permitting externally stored and externally retrieved data to finally be treated like a first class citizen within the host organization. Stated differently, functions and applications operating within the host organization can treat the externally stored and externally retrieved data as though it was natively and locally stored data within the host organization, despite the fact that such data is maintained and stored externally from the core services and applications of the host organization (e.g., the data is not stored within the multi-tenant database environment of the host organization). In fact, core functions and applications operating within the host organization, through the use and practice of the disclosed embodiments, operate wholly agnostic to the fact that such data is stored externally and retrieved from an external repository.

By way of analogy, the ability for core services to natively surface information stored within an externally accessible data repository is achievable because the new off-stack batch querying functionality establishes a facade which mimics all internal native views of accessible data, notwithstanding the reality that the data sought may be stored within an externally managed data repository (e.g., external from the computing infrastructure of the host organization), thus massively simplifying any query attempt initiated by a customer or a customer's application within the host organization's suite of services and functionality.

Contrast this with prior operation of the bulk API framework which receives incoming user requests and then delegates the requests to so-called “Operation” Objects which must then execute the operation required, such as writing to the FileForce platform, updating the status of a job, creating a new batch object, etc., a process flow which is more technically complex, prone to latency, and non-conforming with native data requests internal to the host organization. Additionally, because the prior iteration of the bulk API framework utilizes PL/SQL (Procedural Language for SQL), it is, by necessity, tightly coupled with Oracle's database and primary key structure and as such, it is simply not suitable for use with external data sources. Use and practice of the embodiments described herein therefore provides the additional benefit of abstracting calls for externally stored and managed data from the underlying PL/SQL demanded by interaction with an Oracle database.

According to particular embodiments, a custom Processor Abstraction is specially configured to operate from within the asynchronous API framework (e.g., within the bulk API framework), and thus has the flexibility to ingest data from the Pardot automation platform or from any other external data source. In certain embodiments, a custom message queue handler is further configured to translate a Salesforce Object Query Language (SOQL) request to a Pardot automation platform specific bulk API request. A different custom message queue handler may then be further configured specifically to consume results from the Pardot automation platform and to write to the Core FileForce platform, thus seamlessly consuming any transactions or messages processed by the existing Core Bulk API framework.

According to yet another embodiment, the “facade” operating within the host organization's computing architecture (e.g., within the SalesForce platform) is exposed to internal core services and functionality further permits the creation of user-customizable fields, thus permitting users to extend beyond the default set of fields for any Pardot account and to interact with those user-customizable fields within Pardot or within an external data repository, even when querying the external data repository from within services, functionality, and applications operating from within the host organization's computing environment.

In the following description, numerous specific details are set forth such as examples of specific systems, languages, components, etc., in order to provide a thorough understanding of the various embodiments. It will be apparent, however, to one skilled in the art that these specific details need not be employed to practice the embodiments disclosed herein. In other instances, well-known materials or methods are described in detail in order to avoid unnecessarily obscuring the disclosed embodiments.

In addition to various hardware components depicted in the figures and described herein, embodiments further include various operations that are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software.

Embodiments also relate to an apparatus for performing the operations disclosed herein. This apparatus may be specially constructed for the required purposes, or it may be a general purpose computer selectively activated, configured, or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems appears as set forth in the description below. In addition, embodiments are not described with reference to any particular programming language. It will be appreciated that a variety of programming languages may be used to implement the teachings of the embodiments as described herein.

Embodiments may be provided as a computer program product, or software, that may include a machine-readable medium having stored thereon instructions, which may be used to program a computer system (or other programmable electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.), a machine (e.g., computer) readable transmission medium (electrical, optical, acoustical), etc.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

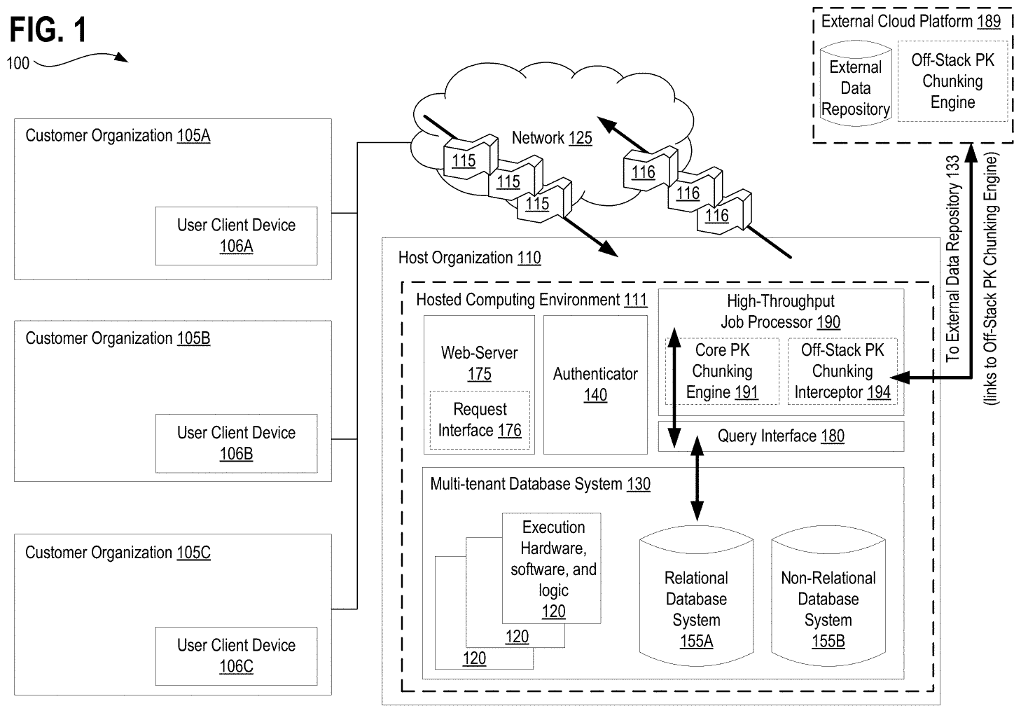

FIG. 1 depicts an exemplary architecture 100 of a cloud computing environment in accordance with described embodiments. In one embodiment, a hosted computing environment 111 is communicably interfaced with a plurality of user client devices 106A-C (e.g., such as mobile devices, smart phones, tablets, PCs, etc.) through host organization 110. In one embodiment, a database system or a multi-tenant database system 130 includes databases 155A and 155B, for example, to store application code, object data, tables, datasets, and underlying database records with user data on behalf of client, or customer, organizations 105A-C, and communities 160A-C (e.g., users of such a database system or tenants of a multi-tenant database system 130 or the affiliated users of such a database system). Such databases include various database system types including, for example, a relational database system 155A and a non-relational database system 155B according to certain embodiments.

Certain embodiments may utilize a client-server computing architecture to supplement features, functionality, or computing resources for the multi-tenant database system 130 or alternatively, a computing grid, or a pool of work servers, or some combination of hosted computing architectures may be utilized to carry out the computational workload and processing demanded of the host organization 110 in conjunction with the multi-tenant database system 130.

The exemplary multi-tenant database system 130 depicted here includes a plurality of underlying hardware, software, and logic elements 120 that implement database functionality and a code execution environment within the host organization 110.

In accordance with one embodiment, multi-tenant database system 130 utilizes the underlying database systems 155A and 155B to service database queries and other data interactions with the multi-tenant database system 130 that communicate with the multi-tenant database system 130 via the query interface. The hardware, software, and logic elements 120 of the multi-tenant database system 130 are separate and distinct from a plurality of customer organizations (105A, 105B, and 105C) which utilize web services and other service offerings as provided by the host organization 110 by communicably interfacing to the host organization 110 via network 125. In such a way, host organization 110 may implement on-demand services, on-demand database services or cloud computing services to subscribing customer organizations 105A-C. Notably, the hardware, software, and logic elements 120 of the multi-tenant database system 130 are separate and distinct are also separate and distinct from the external cloud platform 189 which implements its own functional and data stacks without regard to the operations of the host organization 110.

Further depicted is the host organization 110 receiving input and other requests 115 from a plurality of customer organizations 105A-C via network 125 (such as a public Internet). For example, incoming search queries, database queries, API requests, interactions with displayed graphical user interfaces and displays at the user client devices 106A-C, or other inputs may be received from the customer organizations 105A-C to be processed against the multi-tenant database system 130, or such queries may be constructed from the inputs and other requests 115 for execution against the databases 155 or the query interface 180, pursuant to which results 116 are then returned to an originator or requestor, such as a user of one of the user client devices 106A-C at a respective customer organization 105A-C.

In one embodiment, each customer organization 105A-C is an entity selected from the group consisting of: a separate and distinct remote organization, an organizational group within the host organization 110, a business partner of the host organization 110, or a customer organization 105A-C that subscribes to cloud computing services provided by the host organization 110.

In one embodiment, requests 115 are received at, or submitted to, a web-server 175 within host organization 110. Host organization 110 may receive a variety of requests for processing by the host organization 110 and its multi-tenant database system 130. Incoming requests 115 received at web-server 175 may specify which services from the host organization 110 are to be provided, such as query requests, search request, status requests, database transactions, graphical user interface requests and interactions, processing requests to retrieve, update, or store data on behalf of one of the customer organizations 105A-C, code execution requests, and so forth. Web-server 175 may be responsible for receiving requests 115 from various customer organizations 105A-C via network 125 on behalf of the query interface 180 and for providing a web-based interface or other graphical displays to an end-user user client device 106A-C or machine originating such data requests 115.

The query interface 180 is capable of receiving and executing requested queries against the databases and storage components of the multi-tenant database system 130 so as to return a result set, response, or other requested data in furtherance of the methodologies described. The query interface 180 additionally provides functionality to pass queries from web-server 175 into the multi-tenant database system 130 for execution against the databases 155 for processing search queries, or into the other available data stores of the host organization's computing environment 111. In one embodiment, the query interface 180 implements an Application Programming Interface (API) through which queries may be executed against the databases 155 or the other data stores.

Host organization 110 may implement a request interface 176 via web-server 175 or as a stand-alone interface to receive requests packets or other requests 115 from the user client devices 106A-C. Request interface 176 further supports the return of response packets or other replies and responses 116 in an outgoing direction from host organization 110 to the user client devices 106A-C.

Authenticator 140 operates on behalf of the host organization to verify, authenticate, and otherwise credential users attempting to gain access to the host organization.

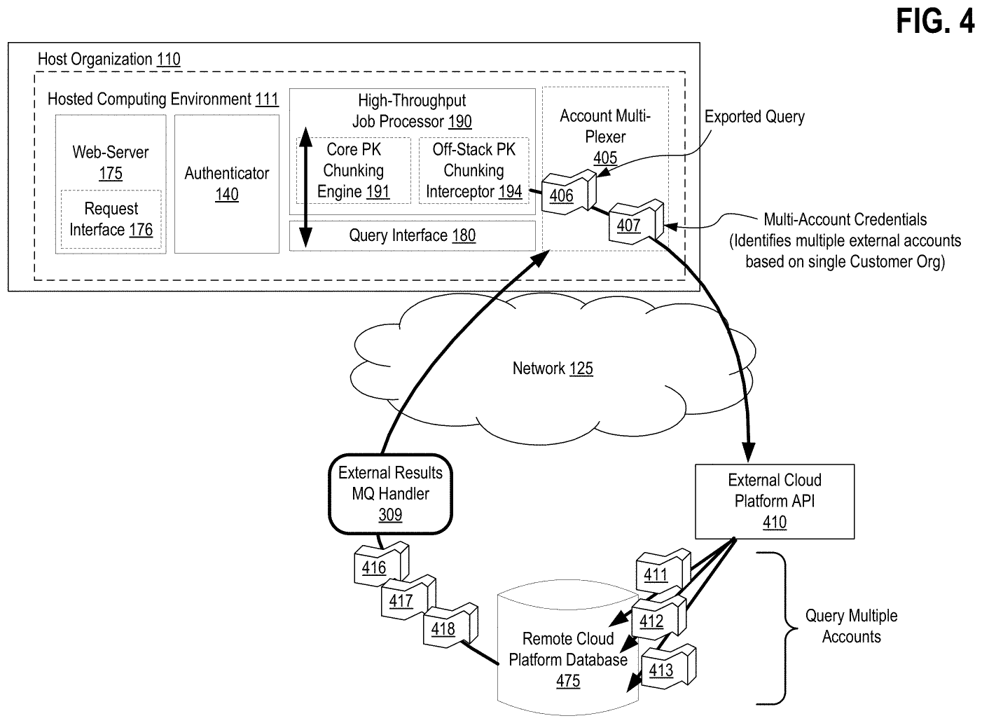

For example, according to one embodiment, the authenticator validates a connected user based on the User ID of the user as is utilized by the host organization's 110 database system as well as a connected User ID of the same user which is utilized by the external cloud platform 189 for the user. As will be described in greater detail below, sometimes a single user or customer organization associated with the host organization 110 corresponds to multiple distinct accounts at the external cloud platform 189, thus necessitating use of an account multi-plexor (e.g., see element 405 of FIG. 4). In such embodiments, while the user may be the same person or entity, the user ID at each of the host organization 110 and the external cloud platform 189 is likely a different user ID entirely, especially in the case where multiple user accounts exist at the external cloud platform 189.

According to certain embodiments, authenticator 140 may further interact with the off-stack PK chunking interceptor 194 to analyze a received query, in order to determine and authenticate a plurality of external accounts located at the external cloud platform 189 on the basis of an association with customer organizations 106A-106C which are affiliated with the host organization. In such an embodiment, authenticator 140 may further provide credentials which are transmitted to the external cloud platform via the link to the external repository 133 so as to authenticate a query sent to the external cloud platform 189 which is affiliated with one or more external accounts at the external cloud platform 189.

Still further depicted within the hosted computing environment 111 is the high-throughput job processor 190 having therein both a core primary key (PK) chunking engine 191 as well as an off-stack PK chunking interceptor 194. The core PK chunking engine 191 operates to receive asynchronous processing requests at the high-throughput job processor 190 for internal processing within the core services and functionality of the host organization 110 which are to be processed against the host organization's internal multi-tenant database system 130. Conversely, because not all queries and database transactions are serviceable via the multi-tenant database system 130, there further is provided the off-stack PK chunking interceptor 194 which operates to listen for, and to intercept incoming jobs, queries, requests, and transactions at the high-throughput job processor 190, which require processing by the external cloud platform 189 housing the external data repository, as shown here.

According to such embodiments, the incoming query received at the high-throughput job processor 190 is determinable by the off-stack PK chunking interceptor 194 to require data or information which is externally stored at an external data repository, and thus, the off-stack PK chunking interceptor 194 intercepts the query, request, job, or transaction in question and parlays the request to an external cloud platform 189 or to an external data repository via the depicted link to the external data repository 133. According to a particular embodiment, there is a custom configurable off-stack PK chunking engine which executes and operates at the external cloud platform 189 which is specifically configurable to receive queries, requests, jobs, and transactions from the off-stack PK chunking interceptor 194 at the host organization and then to process and return a query result or response back to the off-stack PK chunking interceptor 194 at the host organization 110 in reply to any query, job, request, or transaction received from the off-stack PK chunking interceptor 194. Such interfacing between the host organization and the off-stack PK chunking engine is coordinated by the off-stack PK chunking interceptor 194 and transmitted to the external cloud platform 189 via the link to the external data repository 133, as is depicted here. For instance, while the transactions may ultimately be transmitted over a network 125 such as a public Internet or even via a VPN, VLAN, or other network configuration, it is not necessary for such transactions to traverse the public facing web-server 175 and request interface 176 of the host organization, instead bypassing such interfaces and traversing only a dedicated or specially configured interface at the external data repository link 133. In such a way, the external data repository link 133 may provide preferential treatment to transactions being processed collaboratively via the host organization and the external cloud platform 189 which are transmitted back and forth over a dedicated and specially configured external data repository link 133.

In such a way, it is possible for the high-throughput job processor 190 of the host organization 110 to retrieve, surface, and generally integrate data retrieved from an external cloud platform 189 in furtherance of providing the requested data to an analytics engine, to a user, to an application, or to some other core host organization function or service. Thus, a single core service within the host organization 110 may seamlessly access data stored both within the host organization 110 as well as data stored within and accessible from disparate sources, such as data and objects originating from the external cloud platform 189.

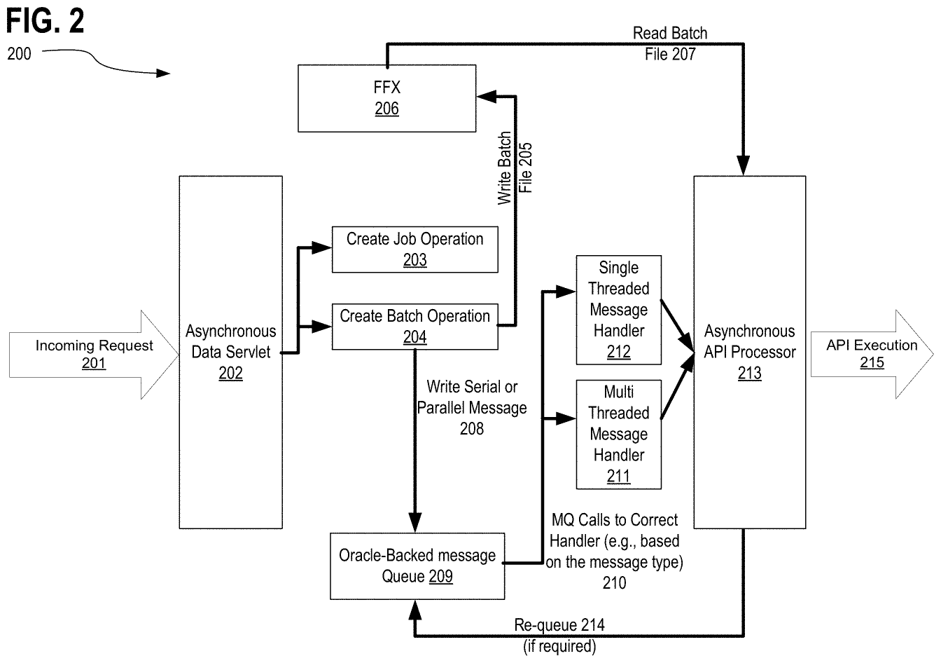

FIG. 2 depicts a flow diagram illustrating an exemplary bulk API flow 200 in accordance with described embodiments.

As shown here, an internal bulk API processing engine, also known as asynchronous API, processes incoming requests 201, queries, jobs, and transactions, such as those arriving at the high-throughput job processor 190 (refer to FIG. 1). These incoming requests 201, queries, jobs, and transactions are serviceable by the multi-tenant database system 130 of the host organization 110 without reference to the external cloud platform 189 and therefore, there is no need for an intercept and relay to the external cloud platform.

As shown here, handling of such incoming requests 201 begins on the left most side of the diagram with capture of the incoming request 201 by the asynchronous data servlet 202. Such requests 201 may originate from an internal service such as an analytics engine, a core service, function, or internally executing application, or even from a user or from an administrator submitting a large query, which is either directly configured for asynchronous processing or in certain circumstances, such a large query may be selected for asynchronous processing by the host organization 110 due to the size of the query or due to resource requirements required to process the query.

As shown here, once the incoming request 201 is received at asynchronous data servlet 202, it is delegated to operations objects, services, or applications capable of executing the operation required in fulfillment of the request. Operation objects include, for example, create job operation 203 and create batch operation 204. Create batch operation 204 may advance to write a batch file (see element 205) to FFX (FileForce) 206 or may alternatively perform other operations such as updating the status of a job or creating a new batch object. Create batch operation 204 may similarly write serial or parallel messages into the Oracle backed message queue (MQ) 209 which in turn passes an MQ call to the correct handler has shown via element 210, thus proceeding with either serial processing (via the single threaded message handler 212) or parallel processing (via the multi-threaded message handler 211) required in fulfillment of the incoming requests 201 received. As depicted, the create batch operation 204 may write serial or parallel message 208 instructions into the Oracle-backed message queue 209. The type of processing implemented (e.g., parallel or serial) may be determined or triggered on the basis of the message type originating from the message queue 209, as written via the create batch operation 204 block. Ultimately flow then advances through the asynchronous API processor 213 and initiates API execution 215.

According to the depicted embodiment, processing at FFX (FileForce) 206 sends a request to read batch file 207 to the asynchronous API processor at block 213, which in turn triggers API execution 215.

In certain circumstances, it is necessary for the asynchronous API processor to trigger a re-queue 214 operation, in which messages or jobs are re-queued or re-enqueued by sending the relevant message or job back to the Oracle-backed message queue 209, after which processing then again proceeds as described above, from the message queue 209, on a subsequent iteration.

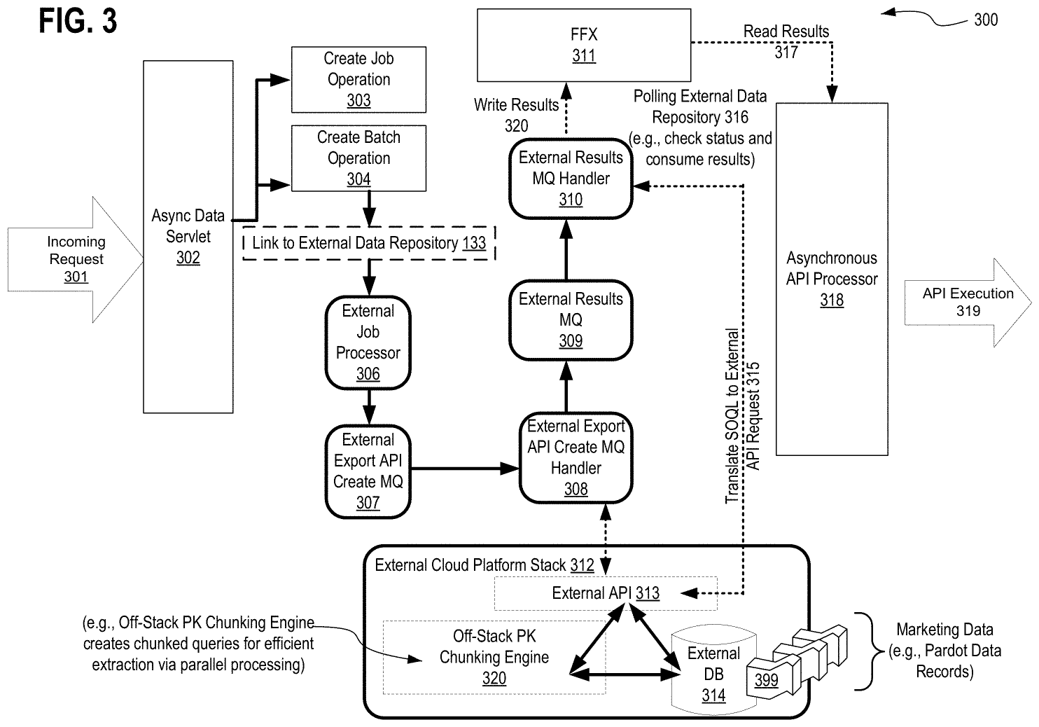

FIG. 3 depicts another flow diagram illustrating an improved bulk API flow with Virtual Entity chunking 300, in accordance with described embodiments.

As shown here, the role and relationship of a job processor abstraction mechanism is shown here as enabling asynchronous job processing of workloads originating within the host organization (see element 110 of FIG. 1) via processing and handling at an external cloud platform (see element 189 of FIG. 1). Also depicted is the manner in which such a job processor abstraction mechanism fits within the asynchronous API (bulk API) processing framework, and thus, has the flexibility to ingest data from Pardot or any other external data source such as the exemplary external cloud platform 189 shown at FIG. 1.

The exemplary bulk API flow with Virtual Entity chunking 300 is an improved bulk API flow that flexibly handles external data sources. The improvements allow scaling of Virtual Entities in a way that accommodates the massive data volume associated with many tenants on either the external cloud platform 189 or within the multi-tenant database environment of the host organization 110, or both.

Importantly, the entire process of query creation and retrieval looks no different from the perspective of the Core bulk query user interface than a typical internal (host organization's server-side) primary key (PK) chunking request using a server primary key chunking http request header. Thus, Virtual Entity business process outsourcing (BPOs) objects are given similar treatment as in-platform/on-stack BPOs processed via the host organization's internal computing architecture, thus permitting externally sourced data to be smoothly integrated into the core services of the host organization 110.

As shown here, there is depicted on the far left side, an incoming request 301 which is received at the asynchronous data servlet 302. A custom configured message queue handler is now further depicted as being capable of translating a received incoming request 301, which is formatted as a SOQL request, into a Pardot bulk API format compliant request which is suitable for relaying the incoming request 301 (in it's translated form) to an external cloud platform 189, such as Pardot. Alternatively, the received incoming request 301 in the format of an SOQL request may be translated into a non-Pardot request, such as a translated request which is compatible with a different external cloud platform 189, other than Pardot. Thus, the improved bulk API flow is not limited to a single external cloud platform 189, such as Pardot, but may be specially configured to accommodate any external cloud platform 189 which is accessible to the host organization via a specially configured link 133 to the data repository of an external cloud platform 189.

Regardless of the targeted external cloud platform 189, there is additionally implemented another custom configured message queue handler which is to consume results from Pardot (or from the targeted external cloud platform 189). In such a way, responses from the targeted external cloud platform 189 may be consumed and processed back on the host organization's side (e.g., via the computing architecture of the host organization 110), effectively providing a hand-off from the external cloud platform 189 back to the host organization 110 where further processing may then occur. According to such embodiments, the custom message queue handler is further to write results back into a core FFX FileForce 311 platform of the host organization 110, such that the received results from the external cloud platform 189 may seamlessly be consumed by any existing core Bulk API framework operating within the host organization 110.

An exemplary code breakdown may therefore be as follows: According to one embodiment, there is a PardotBulkExportJobProcessor which determines if the incoming request 301 directed at the Asynchronous API processor 318 is serviceable via internal processing of the host organization utilizing its multi-tenant database system or alternatively, if servicing of the incoming request 301 is directed at one of the Virtual Entities accessible within the host organization and thus, requires processing by an external cloud platform 189, such as Pardot or another external data repository hosted by a targeted external cloud platform 189.

It is the responsibility of the PardotBulkExportJobProcessor to create a custom message queue and to initiate export for external processing via the Pardot API or via another specially configured API which interfaces to a different external cloud platform.

The PardotBulkApiRequestMessageHandler next operates to parse each incoming request and to translate such received requests on the basis of translation filters into a request which is decipherable by the Pardot API or by whatever external cloud platform API is targeted pursuant to the incoming request. Next, the PardotBulkApiRequestMessageHandler creates an export request to the appropriate Pardot API or the external API as well as creating an additional custom message queue for later ingesting data extracted from the external Pardot automation platform or from the external cloud platform targeted back into the host organization 110. Stated differently, the additional custom message queue is created at the time of message export to listen for and to ultimately receive any returned response, returned dataset, returned acknowledgment, etc., which is sent back from the external cloud platform 189 or from the external Pardot automation platform and received at the host organization 110 for further processing. The additional custom message queue, which is created by the PardotBulkApiRequestMessageHandler at the same time as the export request, thus listens for, captures, and then consumes and processes any such returned response, closing the loop from the time the request is transmitted away from the host organization 110 until such time that a response is received again back at the host organization 110.

The PardotBulkApiPollMessageHandler next polls the Pardot API or the external cloud platform API on a recurring basis to iteratively check for the status of any exported job or message request sent from the host organization to the external cloud platform 189, be it the Pardot platform or otherwise. After processing is complete by the external cloud platform, the polling of external API will ultimately update to a status indicating that processing is complete and that the results from the asynchronous job processing are ready, and thus, the PardotBulkApiPollMessageHandler will next proceed to ingest and consume the data from the external cloud platform or from the external Pardot automation platform and then further proceed to relay or to push those injected results to the Keystone FileForce (FFX) 311 interface within the host organization's 110 computing infrastructure, so as to persist the returned results extracted from the external cloud platform 189 within the common storage system of the host organization (e.g., stored within the multi-tenant database system 130 of the host organization).

Such results are then locally accessible to any core service, application, or function, including to the internal bulk API processor, meaning that analytics operations may be performed on such data results without incurring further overhead costs to communicate with the external data repository as well as being accessible to local core services and functions of the host organization without the unacceptable latency induced when communicating with an external data repository 189. Consequently, records and data may be surfaced to customer facing GUIs in a cohesive manner, thus fulfilling the demand and expectations of the host organization's customers which subscribe to the on-line cloud based services provided by the host organization 110. Stated differently, information may be surfaced without the latency attributable to an external data retrieval which would either cause a time-out issue on the graphical user interface or a perceivable latency (e.g., a perceivable “hang”) at the user's GUI or UX, neither of which is acceptable in terms of an optimal and cohesive user experience.

For example, as was depicted at FIG. 1, the high-throughput job processor (element 190) may receive incoming messages 301 and determine whether the incoming message (e.g., a workload, query, request, transaction, job, etc.) is serviceable via internal processing or if the incoming message requires external processing. If the received message requires internal processing, it is passed to the core PK chunking engine 191 whereas if the received message requires external processing, it is instead intercepted by the off-stack PK chucking interceptor 194 when then intercedes the normal processing, bypassing the core PK chunking engine 191 and foregoes processing of the received message via the multi-tenant database system 130 through the query interface 180 and instead, the off-stack PK chucking interceptor 194 causes the received message to be passed to an API at the external cloud platform 189.

The processing depicted here illustrates a more detailed view of the operations which then occur when the off-stack PK chucking interceptor 194 intercepts a received message and causes the received message to be passed to the external cloud platform 189.

Referring back again to the diagram at FIG. 3, it may be further observed that once an incoming request 301 is received at the asynchronous data servlet (for example, due to the request 301 being intercepted by the off-stack PK chucking interceptor 194), processing advances to the create job operation 303 to translate the received request 301 into the targeted format for the external API and additionally advances to the create batch operation 304 which generates the job request for processing of the translated request via the external cloud platform.

The translated request and the generated batch operations are then exported to the external cloud platform through the link to the external data repository 133 shown here (and also at FIG. 1) which permits linkage with the specially configured API located at the external cloud platform 189. In certain embodiments, the off-stack PK chucking interceptor 194 of the host organization will both intercept and chunk the workload into sub-parts such that the entire job may undergo faster parallel processing, in which case, the received job 301 is translated for the target external API and the generated batch operations specify multiple necessary jobs which are configured to fulfill the original non-translated request. However, in other embodiments, the off-stack PK chucking interceptor 194 of the host organization intercepts the received request 301 but does not break the received request 301 into parts. Rather, the received request 301 is translated as a single request and the create batch operation 304 creates a job request to fulfill the monolithic (e.g., non-broken) job request, which is then transmitted to an off-stack PK chunking engine located at the external cloud platform 189 will perform the chunking of the received job into sub-parts so that it may be processed in parallel, effectively off-loading the chunking responsibility from the host organization 110 to the eternal cloud platform 189.

Regardless of what entity chunks the workload, processing advances to the external job processor 306 which performs the workload(s) in fulfillment of the received request 301 (in its translated form) at the external cloud platform 189. The external export API create message queue operation at block 307 may be utilized to receive and export the appropriate messages to the message queue, permitting jobs to be processed by the external cloud platform. Ultimately, jobs are queued via the external export API which creates the necessary message queue to multi-plex and process the job sub-parts in parallel and processing then advances to the external export API to create the message queue handler 308, which is capable of processing asynchronous (e.g., non-real-time) workloads via the external cloud platform stack 312.

As depicted at the external cloud platform stack 312, the MQ handler 308 of the external cloud platform either interfaces with the external database 314 to retrieve relevant records, results, information, or marketing data 399 (e.g., Pardot data records if utilizing Pardot or other externally available information from another external cloud platform) or alternatively, the MQ handler 308 of the external cloud platform may traverse the off-stack PK chunking engine 320 as shown here, which breaks larger queries into smaller queries or fragments large workloads into small workloads, such that they may be processed in parallel, with retrieval again coming from the external database 314.

As before, results are ultimately retrieved by the external cloud platform and specifically retrieved via functionality and processing executed by the external cloud platform stack 312. Through the external API 313, the results are then returned back through the external results message queue 309 which is configured to poll (element 316), listen for, and to receive and consume the results from the external cloud platform with processing then advancing to the external results MQ handler 310 which then writes the results 320 into the FFX 311 platform within the host organization's core. According to certain embodiments, when results are returned back to the message queue 309, the monitoring further includes iteratively looping through a polling routine to check the status of the external API and the status of a requested job as well as receiving sub-portions of the results (e.g., result sets from multiple sub-portions of a larger job identifiable via an overlapping Primary Key (PK). In such an embodiment, the MQ handler 309 will, as part of its iterative processing, loops through the returned data sub-sets and combine them into an aggregated master result set until such time that all sub-jobs have completed successfully and all sub-portions of the results have been returned, processed, ingested, and aggregated into the master result set.

According to certain embodiments, writing to the FFX service constitutes writing an aggregated master result set compiled within a CSV format into a temporary data store of the host organization which is accessible locally to all core services but which is not persisted as the authoritative master copy, given that the original and thus authoritative copy resides within the external data repository. Consequently, any updates or modifications needed for the dataset are written back to the authoritative copy at the external data repository rather than the temporarily stored dataset at the host organization. Moreover, the temporarily stored dataset at the host organization may be discarded without coordination with or approval from the external data repository as it is not the authoritative version of any of the data extracted from the external data repository 314.

Once the marketing data 399 or other information is returned from the external data repository 314, processed, and written into the host organization's core multi-tenant database system 130 (e.g., via FFX 311 or some other core service), it is then possible for the asynchronous API processor 318 to locally read results 317 for the purposes of surfacing information to a user interface without latency or to perform a variety of statistical reports and analysis without inducing additional costly overhead, thus permitting some function requested by the API execution 319 block to complete its processing locally within the host organization's core. In certain related embodiments, the FFX 311 service is configured to push data back into a queryable SFDC native object via a virtual entity object responsive to the externally extracted data becoming accessible within the host organization, in which case the data set is temporarily stored as a queryable SFDC native object via the virtual entity object, which then in turn triggers the reading of results 317 from the queryable SFDC native object and the return of a single and complete dataset responsive to a query originator having submitted or initiated the originally received request 301 as depicted at the left most portion of the diagram.

Utilizing the above described model, it is therefore possible to expose either large or small datasets or even customized datasets to the customer or end user though the native SalesForce services, functions, applications, and interfaces. In so doing, it is therefore wholly unnecessary for the customer to have any knowledge whatsoever about the external cloud service API, be it the Pardot API or otherwise, nor does the customer even need to be made aware that their query (or their interactions with a GUI that triggers such a query) causes data to be retrieved from the external data repository. Consequently, the overall user-experience is simplified and made to be more cohesive and intuitive from the perspective of the user as it appears to such users as though the requested data had “lived” or been persisted within the host organizations' core services all the time.

In a related embodiment, because the data of the external data repository is made to be accessible from within the host organization's core services in the form of a native query, it is thus possible for customers to create customized reports, including dynamic reports, by creating a custom link to a dashboard view to a data record as specified by the customer. This is true even for records that have their authoritative master copy persisted not within the host organization's computing architecture, but rather, persisted externally on an external data repository. With prior solutions, either a dynamic link is not permissible or the dynamic link will refer to a stale copy of previously copied data, and thus will not update as appropriate.

Consider for example a sales group that creates a basic sales “leads” page or report, but then creates custom configured links to marketing data stored externally within the Pardot automation platform. Because the report may link to a native SFDC object capable of retrieving the data from the external data repository, the report may be created and will function, from the perspective of the user, as though the data were persisted internally to the host organization's core services. Therefore, when the user interacts with such a report and causes information to be surfaced from the underlying dataset supporting the sales “leads” page, that information will be retrieved without excessive latency from the queryable SDFC native object which has the necessary data temporarily stored within a virtual entity object at the FFX 311 internal core platform.

According to certain embodiments, there is further provided a translation layer on the return side through which responses from the external data repository are again translated (e.g., via the external results MQ handler 309) prior to being written back to a virtual entity object at the FFX 311 internal core platform. This translation layer thus transforms any returned responses from the shape or data structure utilized by the external cloud platform into an acceptable shape or data structure which is utilized by virtual entity objects within the host organization pursuant to a virtual entity definition compatible with the SalesForce type data shapes. As depicted, translations may therefore be performed in both directions, into and out of the host organization as well as into and out of the external cloud platform stack 312, as necessary. According to certain embodiments, the external API 313 may therefore receive a translated API request, having been converted from SOQL to an external API request so as to enable the transaction to be processed by the external cloud platform stack 312. The conversion or translation may be performed by the various functional elements of the host organization, including having the external results MQ handler 309 performing the translation of the SOQL to the external API request 315, when necessary, for instance, to perform the polling of external data repository 316 to check the status and to consume results as they become available.

Such translations may be necessary where, for example, there is a unique ID field which may refer to multiple different objects of the host organization. Moreover, the unique ID may refer to objects across different accounts and for which it is unknown at the time the unique ID is created whether or not there will be different accounts in the future, such as new accounts created or old accounts deleted. Therefore, it is further in accordance with described embodiments that the translation layer on the return side performs a mapping operation from the Pardot ID utilized by the returned dataset into a specific object identifier for the virtual entity object compatible with the data shape utilized within the host organization. Thus, the Pardot ID is mapped to a corresponding unique ID utilized internally within the host organization. According to one embodiment, the mapping is bi-directional with the mapping being checked and validated each time there is an external query and an external response so as to ensure that changes to metadata on either the host organization side or the external data repository side are accommodated.

According to yet another embodiment, the improved bulk API flow with Virtual Entity chunking 300 implements a custom job processor specially configured for handling queries to Pardot or other external cloud platforms by forcing applicable transactions originating within the host organization to be re-routed to the external API 313 of the external cloud platform through the specially configured link to the external data repository 133 as shown here.

FIG. 4 depicts data flow through an account multi-plexer 405, in accordance with described embodiments.

As depicted here, there is again a host organization 110 which provides a variety of core services and functions through its hosted computing environment 111. Additionally depicted is now the account multi-plexor 405 which determines that a one to many relationship exists between a single customer organization which resides within the host organization as a tenant and multiple distinct accounts present within and hosted by the external cloud platform.

For instance, it is possible that a single customer organization within the host organization has multiple distinct divisions or a corporate sub-structure having distinct entities such as departments, etc. While it is possible that the one customer organization which is a tenant of the host organization corresponds to only one single account at the external cloud platform, it is also very possible that the external cloud platform 189 stores information on behalf of the various divisions or departments within separate accounts, each having their own account credentials. It is therefore not possible to simply issue a single query to the external account because it would either be incomplete if the query were directed toward one of the multiple accounts or the single query would be ambiguous as it would be unknown to which of the multiple accounts the query is to be directed.

Accordingly, there is further provided an account multi-plexer 405 which interfaces with the off-stack PK chunking interceptor 194 of the host organization. The account multi-plexer 405 functions to receive an exported query from the off-stack PK chunking interceptor 194, which is directed at the external cloud platform API, but then performs an additional query, determination task, or internal lookup to identify the association of one referenced customer organization (e.g., elements 105A-C of FIG. 1) belonging to the host organization with a corresponding one or more accounts belonging to the external cloud platform 189.

According to one embodiment, this information is stored within the database systems of the host organization 110 and thus, the account multi-plexer 405 performs a lookup to determine which accounts of the external cloud platform are listed as being associated with a specified CustomerID or OrgID as referenced by the exported query 406 or based upon the originator that triggered the exported query from the host organization 110 to the external cloud platform 189.

In other embodiments, it may not be known or determinable from within the host organization 110 specifically which accounts at the external cloud platform 189 are associated with the customer organization having tenancy with the host organization.

Therefore, the account multi-plexer 405 may initiate a supplemental query to the external cloud platform 189, passing a CustomerID or OrgID identifying the customer organization within the host organization to the external cloud platform requesting the external cloud platform to return the one or more external accounts located at the external cloud platform known to be associated with the specified CustomerID or OrgID. For example, the external cloud platform may maintain a table specifying each CustomerID or OrgID from the host organization that has permission to query the external cloud platform as well as which accounts at the external cloud platform may be queried.

In yet another embodiment, the account multi-plexer 405 may be located within the external cloud platform and configurable to receive a single query from the host organization specifying a single CustomerID or OrgID which is determinable by the external cloud platform 189 to correspond with multiple accounts at the external cloud platform, in which case, the external cloud platform 189 would then perform a similar lookup to determine which accounts are associated with the single CustomerID or OrgID specified. In so doing, the external cloud platform 189 may offload this processing task and complexity from the host organization to the external cloud platform 189.

Regardless of the manner by which the multiple external accounts are determined (e.g., locally within the host organization or via a query performed at the external cloud platform), ultimately the query for data records must be multi-plexed across multiple external accounts. In so doing, the account multi-plexer 405 at the host organization or at the external cloud platform will duplicate the query for each of the multiple external accounts identified as being associated with the single CustomerID or OrgID specified by the originally received query. This is because the same query must effectively be executed against each of the multiple accounts at the external cloud platform in order to fulfill the single request by the single CustomerID or OrgID. The multiple queries will then be performed and processed by the external cloud platform which will in turn generate multiple data sets, at least one for each query to each account, and the query results will then be passed back to the host organization through an external results MQ handler 309 as described previously, which will perform aggregation functions to bring the multiple datasets back together into a single aggregated dataset responsive to the original query. This is similar to aggregating the sub-sets of data for a fragmented or chunked query operation back into a single aggregated data set.

If the query is large, then it is further possible that the duplicated queries which are generated for each of the multiple distinct accounts at the external cloud platform are also fractured or chunked into sub-parts so that they may be performed in parallel, in which case, there would be multiple queries to collect sub-parts of a per-account query and the multiple chunked queries may conceivably be generated and executed across each of the multiple accounts.

Thus, as shown here, the off-stack PK chunking interceptor 194 upon determining that a received query requires data from the external cloud platform will intercept the query at the high-throughput job processor 190 and then proceed to export the query 406 through the account multi-plexer 405. The account multi-plexer 405 will determine the multiple account credentials 407 corresponding to the multiple external accounts based on a single customer organization's OrgID or CustomerID and then proceed to pass both the exported query 406 and the multi-account credentials 407 to the external cloud platform API 410 which then performs the multiple account queries 411, 412, and 413, at least one query for each account and potentially multiple sub-queries for each of the multiple accounts if any of the queries are chunked or otherwise broken up into sub-parts. The resulting data retrieved from the remote cloud platform database 475 is then returned to the external results MQ handler 309 discussed previously for aggregation. As shown, result sets 416, 417, and 418 are retrieved from the remote cloud platform database 475 and passed through the external results MQ handler 309 to produce a single aggregated dataset within a temporary table or within a virtual table, by writing the information into the multi-tenant database system 130 of the host organization, where it is then exposed as a queryable object to all core services, applications, and functions operating within the host organization, such that information of the virtual table is then retrievable locally so long as it is persisted within the temporary table or within the virtual table.

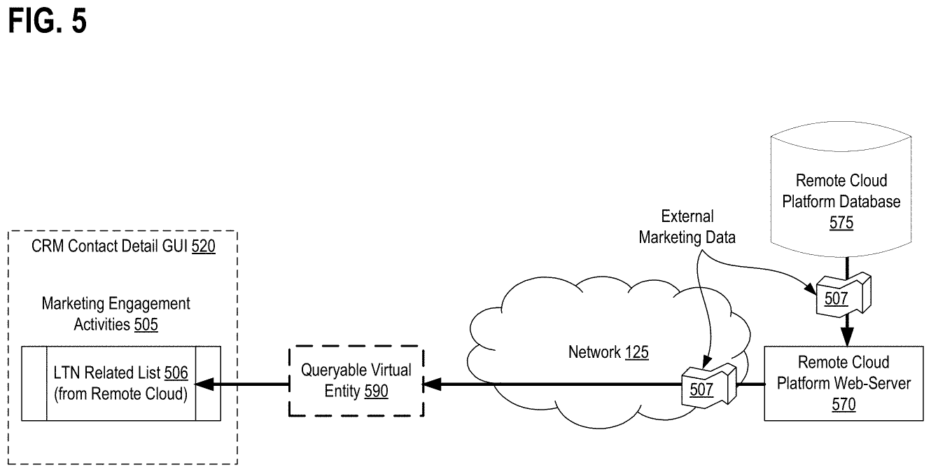

FIG. 5 depicts the source and return flow of externally stored marketing data, in accordance with described embodiments.

According to certain embodiments, the various customer organizations subscribe to different subscription tiers, each with distinct pricing, services, and features. Certain high-level tiers offer an analytics package, which provides pre-packaged as well as customized analytical reports across all or many of the customer organization's various data sources. From the perspective of the customer organization, all of the data resides within the host organization and within the core services offered by the host organization. However, in reality, certain data resides external to the host organization's core services and thus, any such data needing to be surfaced to an application, to a user interface, or to reporting features, such as analytics, needs to be made accessible to the core objects within the host organization. By making the data accessible to the core objects of the host organization, any service, application, function, or query within the host organization which is executed by or on behalf of a customer organization user is thus retrievable via native queries which are presented to the virtual tables through the queryable objects. Stated differently, because the complexity of external data retrieval and query translation is handled by separate functions provided by the host organization's off-stack chunking interceptor 194, it is not necessary for any core service, application, function, or query to be modified to retrieve the external data.

In this simplified view, it may be observed that the external marketing data 507 (e.g., such as Pardot data) which is ultimately to be referenced for statistical analysis by an analytics engine, originates from the remote cloud platform database 575, with the external marketing data 507 being passed through the remote cloud platform web-server 570 which authenticates incoming queries and then fetches the requested data from the remote cloud platform database 575 and responsively returns the external marketing data 507 via the network 125 (e.g., a WAN or a public Internet) to a queryable virtual entity located within the host organization's computing infrastructure.

While a normal “entity” represents a locally stored queryable object, with the data being persisted locally by the host organization 110, a queryable virtual object does not itself have any data. While the virtual object may still be queried, the requested external marketing data 507 must be retrieved from the remote cloud platform database 575. Nevertheless, it is beneficial to represent the remotely stored data as locally accessible to core applications and services executing at the host organization 110 so as to simplify data access logic from those applications and to further permit the virtual objects representing the remotely stored data to be browsed, viewed, and referenced by application builder functionality and workflow builder functionality provided by the host organization, as well as referenced by an analytics engine so as to avoid an uncontrolled spawning of overhead intensive queries between the host organization and the external data source. Stated differently, the off-stack PK chunking interceptor 194 of the host organization described previously deals with the complexity of accessing the remotely stored data on behalf of administrators and application developers so as to simplify application development within the host organization 110 as well as to streamline access to such data from an analytics engine.

Further depicted here is the CRM Contact Detail GUI 520 presenting information which is sourced externally, and thus, surfacing such externally sourced information (such as the external marketing data 507) to the provided GUI 520, surfacing such information so as to, for example, depict marketing engagement activities 505 data via the LTN related list 506 which is displayed via the host organization's internal core applications and services but nevertheless utilizing data which is retrieved from an external location, in this case, the remote cloud platform database 575.

According to the described embodiments, a locally executing application, such as the analytics engine, or GUI interface may perform a local query to the queryable virtual entity which is a defined object within the host organization. Notably, however, the queryable virtual entity 590 does not include any data. Rather, when the queryable virtual entity 590 is queried, the off-stack PK chunking interceptor 194 (see FIG. 1) generates a new query (or multiple queries to account for multiple remote accounts or for faster parallel processing) to the remote cloud platform web-server 570 or to an external cloud platform API requesting the required data. According to certain embodiments, this occurs at run-time when requested data is attempted to be surfaced for display to a user's computing device. In other embodiments, the data is retrieved in an asynchronous manner and potentially scheduled or batched, and then a polling function monitors for the status and completion of the data retrieval before querying the queryable virtual entity 590 for a complete results set which is then returned to the query originator. In the event where an analytics engine is requesting information, a data set may be retrieved from the external remote cloud platform database 575 and then multiple subsequent queries by the analytics engine may be executed against the queryable virtual entity 590, which pulls data from the virtual table temporarily stored within the multi-tenant database system of the host organization.

With such an approach, it is possible to reduce the friction encountered by customers of the host organization seeking to utilize marketing data stored by the Pardot automation platform and thus, incentivize customers to utilize marketing data provided by the Pardot automation platform over competing services due to ease of use to access such data from within the host organization due to the cohesive and seamless coupling between the user and the externally stored data. While there remains significant complexity to retrieve the data, such complexity is hidden away from the user's view and instead managed on the backend by the host organization, so as to maximize customer satisfaction with the marketing data services provide by the Pardot automation system or for data stored within some other external cloud platform which is made accessible through the host organization's suite of core services.

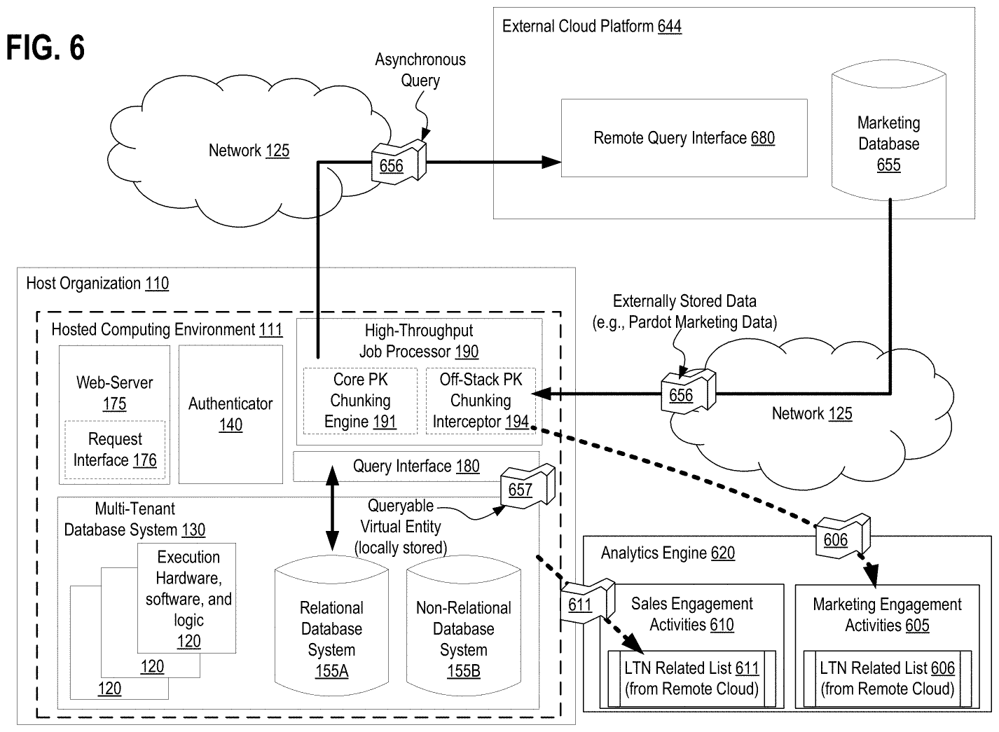

FIG. 6 depicts another exemplary architecture depicting the data flows making externally stored data accessible to an analytics engine 620, in accordance with described embodiments.

As may be observed here, the high-throughput job processor 190 is shown passing an asynchronous query 656 to the remote query interface 680 of the external cloud platform 644 which responsively returns the externally stored data 656, such as Pardot marketing data, from the marketing database 655 of the external cloud platform 644 to the off-stack PK chunking interceptor 194 at the host organization via the network 125 (e.g., a public Internet).

Additionally depicted is a queryable virtual entity object 657 which is locally stored by the multi-tenant database system 130 of the host organization 110 and may thus be queried as a native locally stored object by any application executing at the host organization 110, including allowing native queries by the analytics engine 620 which generates analytical reports for various customer organizations based on their data, including data belonging to the customer organization that is stored externally (e.g., element 656). However, the queryable virtual entity 657 is initially void of any externally stored data 656 and thus, such data must be retrieved from the external cloud platform 644 responsive to the incoming asynchronous query received at the queryable virtual entity 657.

Further depicted is the off-stack PK chunking interceptor 194 passing the returned and aggregated externally stored data 606 to the analytics engine 620 for analysis responsive to a query which was either scheduled on behalf of the analytics engine or possibly triggered by the analytics engine 620. Once the externally stored data 656 is retrieved by the host organization from the external cloud platform 644 it is temporarily written into storage of the host organization, for instance, storing the information within a queryable virtual entity or within a temporary object which is queryable by the queryable virtual entity 657, thus resulting in the externally source and persisted information (e.g., information for which the master authoritative copy resides with the external cloud platform and not with the host organization), now being locally accessible at the host organization. Consequently, the multi-tenant database system 130 of the host organization may successfully respond to a query for the externally sourced information landing at the queryable virtual entity 657 and thus responsively return a result set, such as returning the LTN related list 611 depicted here to the analytics engine 620 responsive to a request, with the dataset populating the LTN related list 611 having been retrieved from the remote or external cloud platform, then stored locally at the host organization, and then returned as a result set to the analytics engine and fulfilled from the temporary storage location at the local database systems of the host organization.

As is depicted here, the returned and aggregated externally stored data 606 is provided to the analytics engine 620 with the same structure and format as data stored within non-virtual (e.g., native and local) queryable objects (e.g., the same as data actually stored and persisted within the host organization's database systems 130 rather than being stored externally). For instance, the aggregated externally stored data 606 from the external cloud platform may include, for example, Contact/Lead, or a Marketing Asset such as a landing page, a marketing form, or any other marketing data available from the external cloud platform 644. When the analytics engine 620 retrieves data for analysis, some portion of the data, such as the depicted sales engagement activities data 610 may be retrieved locally in which case the host organization 110 is the authoritative source of such data, whereas other data, such as the marketing engagement activities data 605 may be retrieved from the external cloud platform 644, in which case the queryable virtual entity accesses a table within the host organization's database systems 130 into which the externally retrieved data is stored at the host organization only temporarily, sufficient to permit the analytics engine 620 to complete its reporting cycle. Subsequently the temporarily stored data will be purged or otherwise discarded, thus necessitating the queryable virtual object 657 which is locally stored but which has no data within it to once again retrieve the externally stored data 656 from the external cloud platform 644, in fulfillment of a subsequent reporting cycle by the analytics engine 620.

According to described embodiments, the host organization executes the off-stack PK chunking interceptor 194 out of view from the users so as to provide a seamless and intuitive unified experience on behalf of the users, notwithstanding the fact that the data being displayed to the user's computing device or analyzed by the analytics engine 620 on behalf of such users originates from a combination of both local and non-local sources.

The queryable virtual entity 657 operates in conjunction with the off-stack PK chunking interceptor 194 to facilitate this data transfer from the external cloud platform responsive to a user attempting to view the externally stored data or responsive to the analytics engine 620 requesting access to such data. The queryable virtual entity 657 is a special type of SalesForce entity, whose actual data for the entity originates from an external source, remote from the host organization. According to certain embodiments, such external data originates from the Pardot automation marketing cloud platform which stores and manages the engagement activities data for sales prospects on behalf of customer organizations. However, the engagement activities data may be retrieved from other marketing platforms as well as other external non-marketing data repositories so long as they permit the remote retrieval of such data.

According to certain embodiments, the external cloud platform's marketing database 655 is also multi-tenant, and thus, it is further necessary to not only request specific data, but to request certain data limited by a particular “tenant” of the marketing database 655, for instance, specifying the OrgID or CustomerID utilized by the external cloud platform. If the external cloud platform has data structured within multiple different accounts corresponding to a single tenant of the host organization, then it may further be necessary to determine the association between the customer organization of the host organization and the multiple distinct accounts housed by the external cloud platform.

According to particular embodiments, a “related accounts” list is maintained by either the host organization or the external cloud platform (or possibly both) which lists the known associations between CustomerID's or OrgID's utilized by the host organization with multiple accounts at the external cloud platform 644 having permission to query the externally stored data 656 from the multiple accounts at the external cloud platform. According to certain embodiments, the OrgID associated with a scheduled analytics report performed by the analytics engine is passed from the host organization to the remote cloud platform and the OrgID is then cross-referenced at the external cloud platform utilizing the related accounts list to identify the corresponding tenant or multiple corresponding tenant accounts within the external cloud platform. The corresponding tenant ID or the list of multiple tenant IDs at the external cloud platform is then utilized at the remote cloud platform to limit the query to only data associated with or stored on behalf of that particular OrgID at the host organization. Thus, a tenant, such as General Motors which may have multiple divisions and multiple distinct accounts at the external cloud platform can query for data and the authentication mechanism of the external cloud platform will cross reference the OrgID for General Motors utilized within the host organization 110 to the corresponding one or more tenant IDs for General Motors utilized within the external cloud platform, thus permitting the external cloud platform to restrict the data query to only data associated with General Motors, whether such data is stored within one or many distinct accounts at the external cloud platform. In such a way, “Customer A” cannot inadvertently or impermissibly access the data of “Customer B” even when querying across clouds via the off-stack PK chunking interceptor 194 to the external cloud computing platform because the external cloud computing platform will validate that the query originator at the host organization is a permissibly connected account (via the related accounts feature) and further because the external cloud platform will take the OrgID passed from the host organization and cross-reference the OrgID to a valid tenant account or to a list of multiple tenant accounts at the external cloud platform which is then utilized to restrict the query to only data permissibly viewable by the matching OrgID and tenant(s) of the host organization and remote cloud platform respectively.

According to related embodiments, the OrgID or Tenant ID is further utilized to determine which database slice or shard at the external cloud platform is storing the data and then the query is further restricted to only that determined database slice or shard so as to further improve the response time and to reduce computational overhead of the asynchronous query.

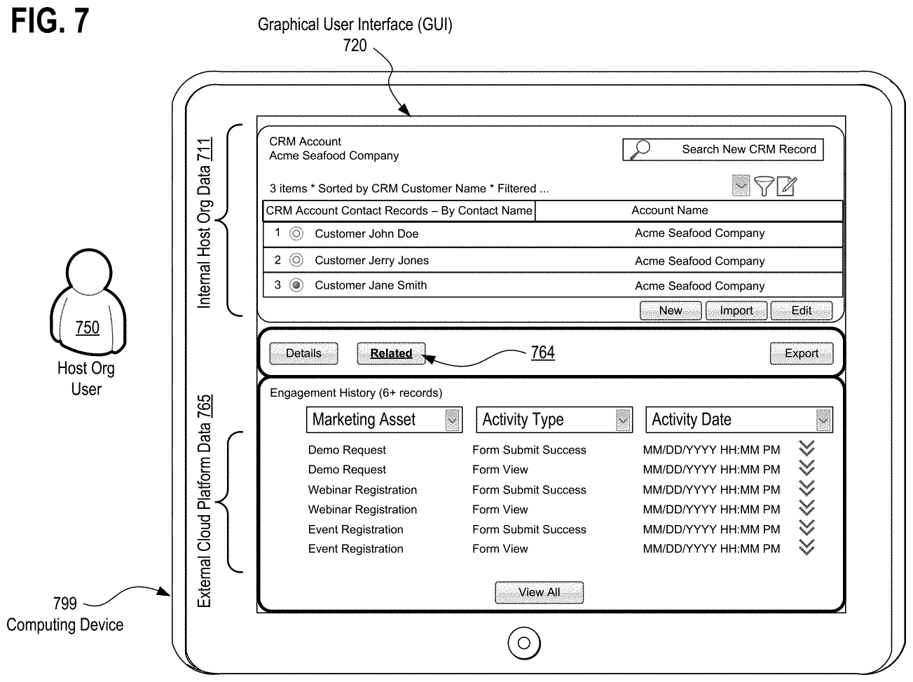

FIG. 7 depicts an exemplary Graphical User Interface (GUI) 720 concurrently displaying both internal host organization data 711 with external cloud platform data 765, in accordance with described embodiments.

As is shown here, there is a host org user 750 utilizing a computing device 799 to display a Graphical User Interface (GUI) 720 with various CRM data displayed to it. Specifically, there is a selected CRM account record displayed for the Acme Seafood Company. Notably, however, the single GUI 720 provided to the host org user 750 is concurrently displaying information which is sourced partially from an internal source of the host organization and partially from an external data repository.

As depicted, the upper portion of the GUI 720 is displaying internal host org data 711 whereas the lower portion of the GUI 720 is displaying external cloud platform data 765. In all likelihood, the host org user 750 would be wholly unaware of this distinction and there is no reason whatsoever for the host org user 750 to be made aware of the disparate data sources.

Nevertheless, through the practice of the disclosed embodiments, it is possible for an application, function, analytics engine, or other service within the host organization to source and utilize (e.g., to display, report, etc.) data for which the authoritative copy is within the host organization concurrently with data for which the authoritative copy is external from the host organization's computing architecture. In so doing, the ultimate end user is thus provided with a more intuitive and cohesive user experience (UX) be it through the displayed GUI 720, analytics usage, dynamic reports and dashboards, applications, etc.

As shown here, notwithstanding the fact that the certain internal host org data 711 is utilized, it may nevertheless be desirable to view or display various data elements which are stored within an external data source, as described in detail above. Unfortunately, the external cloud platform data 765 is not stored within the local CRM database from which the CRM account record is retrieved and moreover, it is not desirable to copy or replicate the external cloud platform data 765 into the CRM database of the host organization. Nevertheless, it is depicted here that by clicking on the “related” button 764, it is possible to display the external cloud platform data 765 which are associated with the CRM record for customer Jane Smith.

Thus, as shown here, a CRM account record is displayed to the GUI 720 which is locally available and through the use of the “related” 764 action button, the externally available Pardot marketing data is also retrieved and displayed to the same GUI 720 despite the fact that the Pardot marketing data is actually external cloud platform data 765. In other embodiments, the display of the external data may be automated and thus negate or eliminate the use of the “related” action button 764.

Consistent with the above discussion, the external cloud platform data 765 may be stored within the Pardot automation platform databases which may reside within a separate remote and external cloud platform. The separate remote and external cloud platform may even utilize a different authenticator and different user IDs for users of the separate cloud system.

The Pardot automation platform provides a world-class B2B Marketing solution for customers of the host organization, tracking literally millions upon millions of engagement activities permitting customer organizations to track prospect interactions (e.g., the interactions of potential customers with marketing campaigns) so as to better understand the effectiveness of marketing campaigns. For example, it may be helpful to know when or if a prospect opens a marketing email, whether or not they visit a campaign landing page, as well as any further activities such as viewing, completing, or submitting a form, signing up for a web seminar, etc. These recorded engagement activities are important for marketers to analyze the effectiveness of their marketing campaigns.

According to the described embodiments, the external cloud platform data 765 is stored in a separate cloud platform, distinct from the cloud platform provided by the host organization. The host organization provides various GUIs and applications by which customer organizations may view internally accessible host organization data and records and also view the external cloud platform data 765. Practice of the described embodiments permits users to intuitively and seamlessly view both the internal host org data 711 and the external cloud platform data 765 concurrently within an integrated and centralized view via the GUI 720.

With respect to the Pardot system specifically, such a unified user interface therefore provides sales and marketing teams with valuable insights into prospect activities as well as increasing the efficiency of related lead management processes. Such a centralized view, as provided by GUI 720, additionally eliminates the potential for obstacles within the sales funnel which may otherwise result in potential leads dropping out of the sales process entirely. Different use cases may be solved by retrieving externally stored data from other external cloud platforms into the host organization's virtual objects for local reference.

Because Salesforce.com's cloud computing platform (e.g., the host organization 110) provides both CRM and marketing domain solutions, the host organization is uniquely situated to deliver an integrated solution and centralized view of CRM data and related records, including the external cloud platform data 765, to customers of the host organization.

Having both sales and marketing data available from a centralized and integrated view, as depicted here, improved collaboration amongst sales and marketing teams may be realized.

In certain embodiments, data is retrieved in real-time responsive to ad-hoc queries whereas in other circumstances, data is retrieved via asynchronous processing.

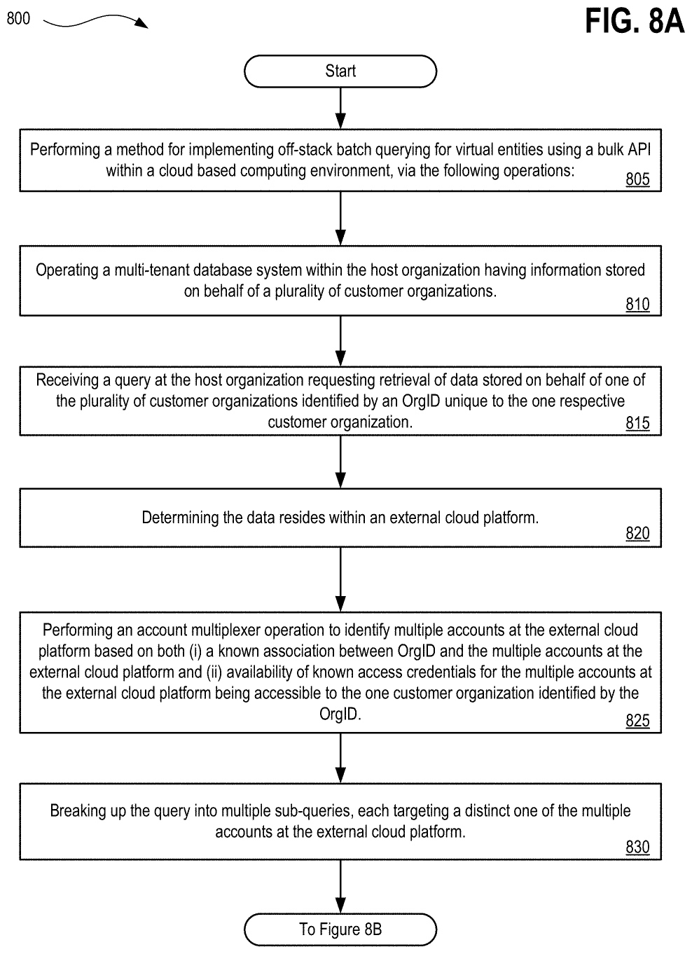

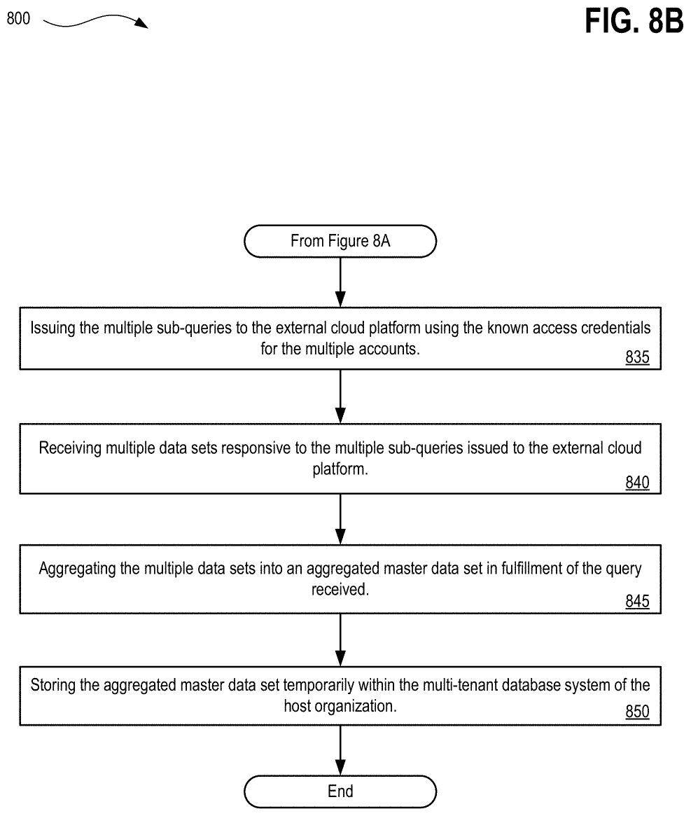

FIGS. 8A and 8B depict a flow diagram illustrating a method 800 for implementing off-stack batch querying for virtual entities using a bulk API within a cloud based computing environment (e.g., such as a hosted application) within a computing environment such as a database system implementation supported by a processor and a memory to execute such functionality to provide cloud based on-demand functionality to users, customers, and subscribers.

Method 800 may be performed by processing logic that may include hardware (e.g., circuitry, dedicated logic, programmable logic, microcode, etc.), software (e.g., instructions run on a processing device) to perform various operations such as executing, transmitting, receiving, analyzing, triggering, pushing, recommending, defining, retrieving, parsing, persisting, exposing, loading, operating, generating, storing, maintaining, creating, returning, presenting, interfacing, communicating, querying, processing, providing, determining, displaying, updating, sending, etc., in pursuance of the systems and methods as described herein. For example, the hosted computing environment 111, the off-stack PK chunking interceptor 194, and the database system 130 as depicted at FIG. 1, et seq., as well as other complementary systems such as the external host platform and the external API, may operate in collaboration to implement the described methodologies. Some of the blocks and/or operations listed below are optional in accordance with certain embodiments. The numbering of the blocks presented is for the sake of clarity and is not intended to prescribe an order of operations in which the various blocks must occur.

With reference to the method 800 depicted at FIG. 8A, at block 805, processing begins by performing a method for implementing off-stack batch querying for virtual entities using a bulk API within a cloud based computing environment, via the following operations:

At block 810, processing logic operates a multi-tenant database system within the host organization having information stored on behalf of a plurality of customer organizations.

At block 815, processing logic receives a query at the host organization requesting retrieval of data stored on behalf of one of the plurality of customer organizations identified by an OrgID unique to the one respective customer organization.

At block 820, processing logic determines the data resides within an external cloud platform.

At block 825, performs an account multiplexer operation to identify multiple accounts at the external cloud platform based on both (i) a known association between OrgID and the multiple accounts at the external cloud platform and (ii) availability of known access credentials for the multiple accounts at the external cloud platform being accessible to the one customer organization identified by the OrgID.

At block 830, processing logic breaks up the query into multiple sub-queries, each targeting a distinct one of the multiple accounts at the external cloud platform.

Processing then advances to FIG. 8B where the flow diagram 800 continues at block 835, in which processing logic issues the multiple sub-queries to the external cloud platform using the known access credentials for the multiple accounts.

At block 840, processing logic receives multiple data sets responsive to the multiple sub-queries issued to the external cloud platform.

At block 845, processing logic aggregates the multiple data sets into an aggregated master data set in fulfillment of the query received.

At block 850, processing logic stores the aggregated master data set temporarily within the multi-tenant database system of the host organization.

Processing then terminates according to this particular embodiment.

According to another embodiment of method 800, determining the data resides within the external cloud platform includes determining that an authoritative master copy of the data is persisted by an external data repository at the external cloud platform.

According to another embodiment, method 800 further includes: exposing a queryable virtual object within the host organization. According to such an embodiment, the queryable virtual object is accessible via native queries to functions, services, and applications executing within the host organization on behalf of the plurality of customer organizations.

According to another embodiment of method 800, the queryable virtual object persists no data on behalf of any of the plurality of customer organizations.

According to another embodiment of method 800, determining the data resides within the external cloud platform is based at least in part on the query targeting the queryable virtual object which is pre-configured to responsively retrieve data from the external cloud platform upon receiving any query.

According to another embodiment, method 800 further includes: exposing a queryable virtual object within the host organization pre-configured to retrieve data from the external cloud platform responsive to being specified as the target of a database query; responsively retrieving the data from the external cloud platform and storing the aggregated master data set temporarily within the multi-tenant database system of the host organization; and accessing the aggregated master data set locally from the multi-tenant database system of the host organization in fulfillment of the query received.

According to another embodiment of method 800, receiving the query at the host organization includes: receiving an asynchronous query from an analytics engine of the host organization on behalf of the one customer organization identified by the OrgID; and determining the asynchronous query requires data retrieval from the external cloud platform; transmitting the asynchronous query to an off-stack batch processor located at the external cloud platform; and in which the computer-implemented method further includes: (i) repeatedly accessing the aggregated master data set temporarily stored within the multi-tenant database system in fulfillment of a plurality of queries from the analytics engine; and (ii) purging the aggregated master data set temporarily stored within the multi-tenant database system rendering the aggregated master data set inaccessible from the host organization without a new data retrieval operation from the external cloud platform.

According to another embodiment of method 800, determining the data resides within an external cloud platform includes one of: receiving the query having query parameters encoded therein targeting a queryable virtual object pre-configured to retrieve the data from the external cloud platform; receiving the query having an object or table name specified therein corresponding to the queryable virtual object; and receiving the query having a custom data type pre-determined to correspond to data accessible from the external cloud platform and inaccessible from within the host organization without issuing external queries to the external cloud platform.

According to another embodiment of method 800, performing an account multiplexer operation to identify multiple accounts at the external cloud platform, includes: transmitting the OrgID uniquely identifying the one customer organization from the host organization to the external cloud platform, in which the external cloud platform responsively performs an account lookup to identify the multiple accounts at the external cloud platform known to be associated with the one customer organization based on the OrgID transmitted; and receiving external account identifiers from the external cloud platform for each of the multiple accounts at the external cloud platform known to be associated with the one customer organization; retrieving foreign authentication credentials from within the host organization via a query to the multi-tenant database system of the host organization utilizing the OrgID and the access authority of the OrgID; and transmitting the foreign authentication credentials for the external account identifiers to the external cloud platform to gain access to the data specified by the query which is hosted by the external cloud platform.

According to another embodiment of method 800, performing an account multiplexer operation to identify multiple accounts at the external cloud platform, includes: performing an account lookup at the host organization utilizing the OrgID to identify external account identifiers for the multiple accounts at the external cloud platform known to be associated with the one customer organization uniquely identified by the OrgID; and retrieving foreign authentication credentials from within the host organization for each of the external account identifiers; and in which issuing the multiple sub-queries to the external cloud platform using the known access credentials for the multiple accounts includes transmitting the foreign authentication credentials with the multiple sub-queries to the external cloud platform.

According to another embodiment of method 800, the query received includes an asynchronous query received at a high-throughput job processor of the host organization; and in which the computer-implemented method further includes: intercepting the asynchronous query received via an off-stack chunking interceptor; bypassing processing of the intercepted asynchronous query at the host organization and re-routing the intercepted asynchronous query for processing via the external cloud platform over a link to an external data repository of the external cloud platform; and polling the external data repository repeatedly for completion status of the processing of the asynchronous query; and consuming all results received at the host organization from the external data repository in fulfillment of processing the asynchronous query at the external cloud platform.

According to another embodiment of method 800, breaking up the query into multiple sub-queries, further includes: instructing the external cloud platform to process the multiple sub-queries in parallel.

According to another embodiment, method 800 further includes: determining the query received is an asynchronous query; chunking the asynchronous query into multiple parts on the basis of a common primary key shared by all of the multiple parts, each capable of executing in parallel at the external cloud platform; and transmitting the multiple parts of the asynchronous query to the external cloud platform for parallel processing.

According to another embodiment of method 800, breaking up the query into multiple sub-queries, each targeting a distinct one of the multiple accounts at the external cloud platform, further includes: fragmenting at least one of the multiple sub-queries for one of the multiple accounts into additional query sub-parts utilizing a common primary key shared by all of the additional query sub-parts; and instructing the external cloud platform to execute the additional query sub-parts using parallel processing.

According to another embodiment, method 800 further includes: determining the query received is an asynchronous query; transmitting the asynchronous query to the external cloud platform with a request for parallel processing; and in which the external cloud platform responsively chunks the asynchronous query into multiple parts on the basis of a common primary key shared by all of the multiple parts and subjecting each of the multiple parts to parallel processing at the external cloud platform.

According to another embodiment of method 800, aggregating the multiple data sets into the aggregated master data set in fulfillment of the query received includes: collecting each of the multiple data sets returned from the external cloud platform; iteratively polling the external cloud platform for completion status of the multiple sub-queries issued to the external cloud platform; and aggregating the multiple data sets at the host organization into the aggregated master data set utilizing a common primary key shared by all of the multiple data sets.

In accordance with a particular embodiment, there is a non-transitory computer readable storage medium having instructions stored thereupon that, when executed by a host organization having at least a processor and a memory therein, the instructions cause the processor to perform operations including: interfacing with a multi-tenant database system of the host organization having information stored on behalf of a plurality of customer organizations; receiving a query at the host organization requesting retrieval of data stored on behalf of one of the plurality of customer organizations identified by an OrgID unique to the one respective customer organization; determining the data resides within an external cloud platform; performing an account multiplexer operation to identify multiple accounts at the external cloud platform based on both (i) a known association between OrgID and the multiple accounts at the external cloud platform and (ii) availability of known access credentials for the multiple accounts at the external cloud platform being accessible to the one customer organization identified by the OrgID; breaking up the query into multiple sub-queries, each targeting a distinct one of the multiple accounts at the external cloud platform; issuing the multiple sub-queries to the external cloud platform using the known access credentials for the multiple accounts; receiving multiple data sets responsive to the multiple sub-queries issued to the external cloud platform; aggregating the multiple data sets into an aggregated master data set in fulfillment of the query received; and storing the aggregated master data set temporarily within the multi-tenant database system of the host organization.

According to yet another embodiment, there is a specially configurable system, customized to include a memory to store instructions; a set of one or more processors; and a non-transitory machine-readable storage medium that provides instructions that, when executed by the set of one or more processors, the instructions stored in the memory are configurable to cause the system to perform the following operations: executing instructions via the processor configurable to cause the system to operate an interface to a multi-tenant database system within the host organization having information stored on behalf of a plurality of customer organizations; executing instructions via the processor configurable to cause the system to operate a receive interface to receive queries at the host organization; receiving a query at the host organization requesting retrieval of data stored on behalf of one of the plurality of customer organizations identified by an OrgID unique to the one respective customer organization; determining the data resides within an external cloud platform; performing an account multiplexer operation to identify multiple accounts at the external cloud platform based on both (i) a known association between OrgID and the multiple accounts at the external cloud platform and (ii) availability of known access credentials for the multiple accounts at the external cloud platform being accessible to the one customer organization identified by the OrgID; breaking up the query into multiple sub-queries, each targeting a distinct one of the multiple accounts at the external cloud platform; issuing the multiple sub-queries to the external cloud platform using the known access credentials for the multiple accounts; receiving multiple data sets responsive to the multiple sub-queries issued to the external cloud platform; aggregating the multiple data sets into an aggregated master data set in fulfillment of the query received; and storing the aggregated master data set temporarily within the multi-tenant database system of the host organization.

According to another embodiment, the systems and methods operate to implement a cloud computing platform to provide on-demand cloud based computing services to subscribers of the cloud computing platform; and in which end users of the cloud computing platform are each associated with one of the plurality of customer organizations having subscriber access to the on-demand cloud based computing services provided by the cloud computing platform.

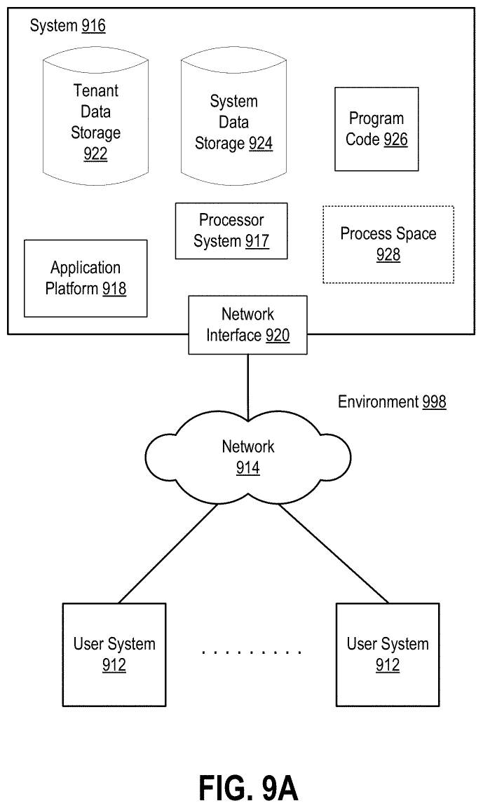

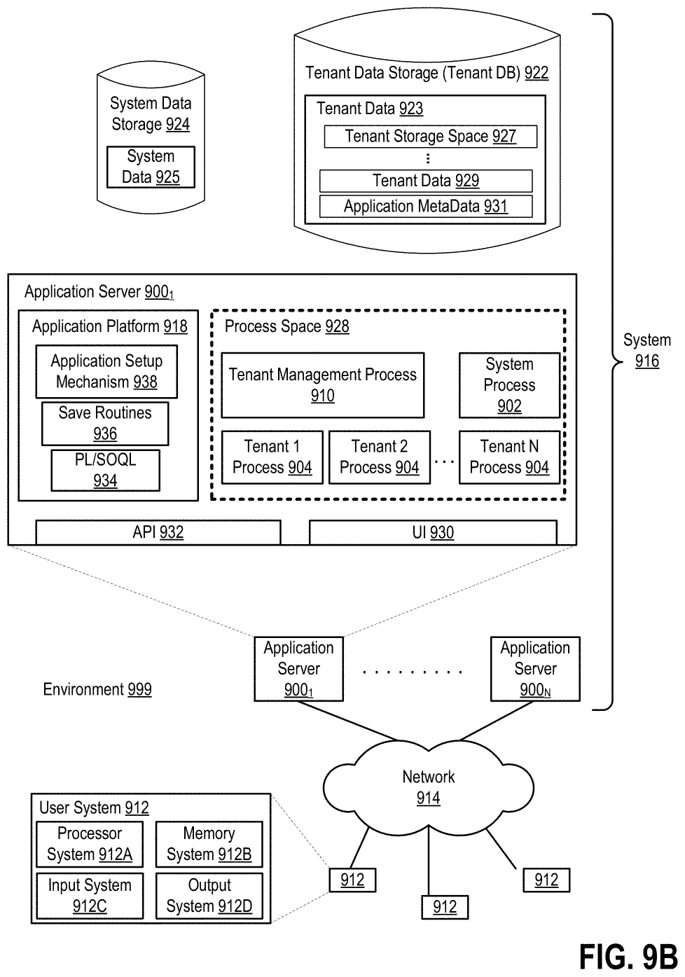

FIG. 9A illustrates a block diagram of an environment 998 in which an on-demand database service may operate in accordance with the described embodiments. Environment 998 may include user systems 912, network 914, system 916, processor system 917, application platform 918, network interface 920, tenant data storage 922, system data storage 924, program code 926, and process space 928. In other embodiments, environment 998 may not have all of the components listed and/or may have other elements instead of, or in addition to, those listed above.

Environment 998 is an environment in which an on-demand database service exists. User system 912 may be any machine or system that is used by a user to access a database user system. For example, any of user systems 912 can be a handheld computing device, a mobile phone, a laptop computer, a work station, and/or a network of computing devices. As illustrated in FIG. 9A (and in more detail in FIG. 9B) user systems 912 might interact via a network 914 with an on-demand database service, which is system 916.

An on-demand database service, such as system 916, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 916” and “system 916” is used interchangeably herein. A database image may include one or more database objects. A relational database management system (RDMS) or the equivalent may execute storage and retrieval of information against the database object(s). Application platform 918 may be a framework that allows the applications of system 916 to run, such as the hardware and/or software, e.g., the operating system. In an embodiment, on-demand database service 916 may include an application platform 918 that enables creation, managing and executing one or more applications developed by the provider of the on-demand database service, users accessing the on-demand database service via user systems 912, or third party application developers accessing the on-demand database service via user systems 912.

The users of user systems 912 may differ in their respective capacities, and the capacity of a particular user system 912 might be entirely determined by permissions (permission levels) for the current user. For example, where a salesperson is using a particular user system 912 to interact with system 916, that user system has the capacities allotted to that salesperson. However, while an administrator is using that user system to interact with system 916, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 914 is any network or combination of networks of devices that communicate with one another. For example, network 914 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it is understood that the networks that the claimed embodiments may utilize are not so limited, although TCP/IP is a frequently implemented protocol.

User systems 912 might communicate with system 916 using TCP/IP and, at a higher network level, use other common Internet protocols to communicate, such as HTTP, FTP, AFS, WAP, etc. In an example where HTTP is used, user system 912 might include an HTTP client commonly referred to as a “browser” for sending and receiving HTTP messages to and from an HTTP server at system 916. Such an HTTP server might be implemented as the sole network interface between system 916 and network 914, but other techniques might be used as well or instead. In some implementations, the interface between system 916 and network 914 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 916, shown in FIG. 9A, implements a web-based customer relationship management (CRM) system. For example, in one embodiment, system 916 includes application servers configured to implement and execute CRM software applications as well as provide related data, code, forms, webpages and other information to and from user systems 912 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 916 implements applications other than, or in addition to, a CRM application. For example, system 916 may provide tenant access to multiple hosted (standard and custom) applications, including a CRM application. User (or third party developer) applications, which may or may not include CRM, may be supported by the application platform 918, which manages creation, storage of the applications into one or more database objects and executing of the applications in a virtual machine in the process space of the system 916.

One arrangement for elements of system 916 is shown in FIG. 9A, including a network interface 920, application platform 918, tenant data storage 922 for tenant data 923, system data storage 924 for system data 925 accessible to system 916 and possibly multiple tenants, program code 926 for implementing various functions of system 916, and a process space 928 for executing MTS system processes and tenant-specific processes, such as running applications as part of an application hosting service. Additional processes that may execute on system 916 include database indexing processes.

Several elements in the system shown in FIG. 9A include conventional, well-known elements that are explained only briefly here. For example, each user system 912 may include a desktop personal computer, workstation, laptop, PDA, cell phone, or any wireless access protocol (WAP) enabled device or any other computing device capable of interfacing directly or indirectly to the Internet or other network connection. User system 912 typically runs an HTTP client, e.g., a browsing program, such as Microsoft's Internet Explorer browser, a Mozilla or Firefox browser, an Opera, or a WAP-enabled browser in the case of a smartphone, tablet, PDA or other wireless device, or the like, allowing a user (e.g., subscriber of the multi-tenant database system) of user system 912 to access, process and view information, pages and applications available to it from system 916 over network 914. Each user system 912 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 916 or other systems or servers. For example, the user interface device can be used to access data and applications hosted by system 916, and to perform searches on stored data, and otherwise allow a user to interact with various GUI pages that may be presented to a user. As discussed above, embodiments are suitable for use with the Internet, which refers to a specific global internetwork of networks. However, it is understood that other networks can be used instead of the Internet, such as an intranet, an extranet, a virtual private network (VPN), a non-TCP/IP based network, any LAN or WAN or the like.

According to one embodiment, each user system 912 and all of its components are operator configurable using applications, such as a browser, including computer code run using a central processing unit such as an Intel Pentium® processor or the like. Similarly, system 916 (and additional instances of an MTS, where more than one is present) and all of their components might be operator configurable using application(s) including computer code to run using a central processing unit such as processor system 917, which may include an Intel Pentium® processor or the like, and/or multiple processor units.

According to one embodiment, each system 916 is configured to provide webpages, forms, applications, data and media content to user (client) systems 912 to support the access by user systems 912 as tenants of system 916. As such, system 916 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS may include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It is understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 9B illustrates another block diagram of an embodiment of elements of FIG. 9A and various possible interconnections between such elements in accordance with the described embodiments. FIG. 9B also illustrates environment 999. However, in FIG. 9B, the elements of system 916 and various interconnections in an embodiment are illustrated in further detail. More particularly, FIG. 9B shows that user system 912 may include a processor system 912A, memory system 912B, input system 912C, and output system 912D. FIG. 9B shows network 914 and system 916. FIG. 9B also shows that system 916 may include tenant data storage 922, having therein tenant data 923, which includes, for example, tenant storage space 927, tenant data 929, and application metadata 931. System data storage 924 is depicted as having therein system data 925. Further depicted within the expanded detail of application servers 9001-N are User Interface (UI) 930, Application Program Interface (API) 932, application platform 918 includes PL/SOQL 934, save routines 936, application setup mechanism 938, process space 928 includes system process space 902, tenant 1-N process spaces 904, and tenant management process space 910. In other embodiments, environment 999 may not have the same elements as those listed above and/or may have other elements instead of, or in addition to, those listed above.

User system 912, network 914, system 916, tenant data storage 922, and system data storage 924 were discussed above in FIG. 9A. As shown by FIG. 9B, system 916 may include a network interface 920 (of FIG. 9A) implemented as a set of HTTP application servers 900, an application platform 918, tenant data storage 922, and system data storage 924. Also shown is system process space 902, including individual tenant process spaces 904 and a tenant management process space 910. Each application server 900 may be configured to tenant data storage 922 and the tenant data 923 therein, and system data storage 924 and the system data 925 therein to serve requests of user systems 912. The tenant data 923 might be divided into individual tenant storage areas (e.g., tenant storage space 927), which can be either a physical arrangement and/or a logical arrangement of data. Within each tenant storage space 927, tenant data 929, and application metadata 931 might be similarly allocated for each user. For example, a copy of a user's most recently used (IVIRU) items might be stored to tenant data 929. Similarly, a copy of MRU items for an entire organization that is a tenant might be stored to tenant storage space 927. A UI 930 provides a user interface and an API 932 provides an application programmer interface into system 916 resident processes to users and/or developers at user systems 912. The tenant data and the system data may be stored in various databases, such as one or more Oracle™ databases.

Application platform 918 includes an application setup mechanism 938 that supports application developers' creation and management of applications, which may be saved as metadata into tenant data storage 922 by save routines 936 for execution by subscribers as one or more tenant process spaces 904 managed by tenant management process space 910 for example. Invocations to such applications may be coded using PL/SOQL 934 that provides a programming language style interface extension to API 932. Invocations to applications may be detected by one or more system processes, which manages retrieving application metadata 931 for the subscriber making the invocation and executing the metadata as an application in a virtual machine.

Each application server 900 may be communicably coupled to database systems, e.g., having access to system data 925 and tenant data 923, via a different network connection. For example, one application server 900i might be coupled via the network 914 (e.g., the Internet), another application server 900N-1 might be coupled via a direct network link, and another application server 900N might be coupled by yet a different network connection. Transfer Control Protocol and Internet Protocol (TCP/IP) are typical protocols for communicating between application servers 900 and the database system. However, it will be apparent to one skilled in the art that other transport protocols may be used to optimize the system depending on the network interconnect used.

In certain embodiments, each application server 900 is configured to handle requests for any user associated with any organization that is a tenant. Because it is desirable to be able to add and remove application servers from the server pool at any time for any reason, there is preferably no server affinity for a user and/or organization to a specific application server 900. In one embodiment, therefore, an interface system implementing a load balancing function (e.g., an F5 Big-IP load balancer) is communicably coupled between the application servers 900 and the user systems 912 to distribute requests to the application servers 900. In one embodiment, the load balancer uses a least connections algorithm to route user requests to the application servers 900. Other examples of load balancing algorithms, such as round robin and observed response time, also can be used. For example, in certain embodiments, three consecutive requests from the same user may hit three different application servers 900, and three requests from different users may hit the same application server 900. In this manner, system 916 is multi-tenant, in which system 916 handles storage of, and access to, different objects, data and applications across disparate users and organizations.

As an example of storage, one tenant might be a company that employs a sales force where each salesperson uses system 916 to manage their sales process. Thus, a user might maintain contact data, leads data, customer follow-up data, performance data, goals and progress data, etc., all applicable to that user's personal sales process (e.g., in tenant data storage 922). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 916 that are allocated at the tenant level while other data structures might be managed at the user level. Because an MTS might support multiple tenants including possible competitors, the MTS may have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 916 might also maintain system level data usable by multiple tenants or other data. Such system level data might include industry reports, news, postings, and the like that are sharable among tenants.

In certain embodiments, user systems 912 (which may be client systems) communicate with application servers 900 to request and update system-level and tenant-level data from system 916 that may require sending one or more queries to tenant data storage 922 and/or system data storage 924. System 916 (e.g., an application server 900 in system 916) automatically generates one or more SQL statements (e.g., one or more SQL queries) that are designed to access the desired information. System data storage 924 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects as described herein. It is understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It is understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

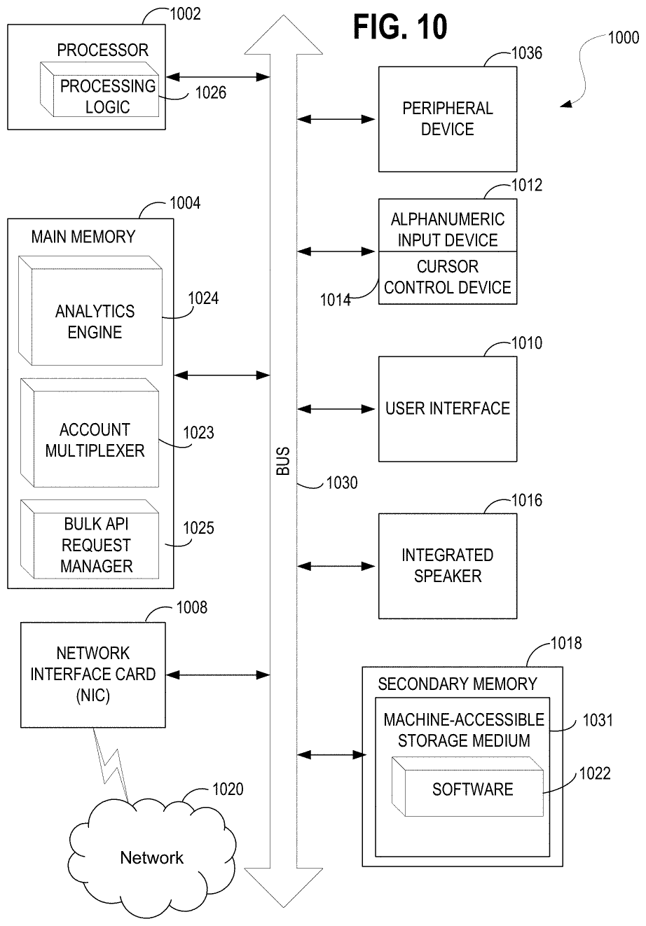

FIG. 10 illustrates a diagrammatic representation of a machine 1000 in the exemplary form of a computer system, in accordance with one embodiment, within which a set of instructions for causing the machine/computer system 1000 to perform any one or more of the methodologies discussed herein, may be executed. In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, or as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1000 includes a processor 1002, a main memory 1004 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 1018 (e.g., a persistent storage device including hard disk drives and a persistent database and/or a multi-tenant database implementation), which communicate with each other via a bus 1030. Main memory 1004 includes an analytics engine 1024, account multiplexer 1023 and bulk API request manager 1025 by which to transmit data, including external data to the internal environment, as well as managing, and processing queries and external data, in accordance with described embodiments. Main memory 1004 and its sub-elements are operable in conjunction with processing logic 1026 and processor 1002 to perform the methodologies discussed herein.

Processor 1002 represents one or more general-purpose processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1002 may also be one or more special-purpose processing devices such as an application specific integrated circuit (ASIC), a field programmable gate array (FPGA), a digital signal processor (DSP), network processor, or the like. Processor 1002 is configured to execute the processing logic 1026 for performing the operations and functionality which is discussed herein.

The computer system 1000 may further include a network interface card 1008. The computer system 1000 also may include a user interface 1010 (such as a video display unit, a liquid crystal display, etc.), an alphanumeric input device 1012 (e.g., a keyboard), a cursor control device 1014 (e.g., a mouse), and a signal generation device 1016 (e.g., an integrated speaker). The computer system 1000 may further include peripheral device 1036 (e.g., wireless or wired communication devices, memory devices, storage devices, audio processing devices, video processing devices, etc.).

The secondary memory 1018 may include a non-transitory machine-readable storage medium or a non-transitory computer readable storage medium or a non-transitory machine-accessible storage medium 1031 on which is stored one or more sets of instructions (e.g., software 1022) embodying any one or more of the methodologies or functions described herein. The software 1022 may also reside, completely or at least partially, within the main memory 1004 and/or within the processor 1002 during execution thereof by the computer system 1000, with the main memory 1004 and the processor 1002 also constituting machine-readable storage media. The software 1022 may further be transmitted or received over a network 1020 via the network.

While the subject matter disclosed herein has been described by way of example and in terms of the specific embodiments, it is to be understood that the claimed embodiments are not limited to the explicitly enumerated embodiments disclosed. On the contrary, the disclosure is intended to cover various modifications and similar arrangements as are apparent to those skilled in the art. Therefore, the scope of the appended claims is to be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A computer-implemented method performed by a host organization having at least a processor and a memory therein, wherein the method comprises:
operating a multi-tenant database system within the host organization having information stored on behalf of a plurality of customer organizations;
receiving a query at the host organization requesting retrieval of data stored on behalf of one of the plurality of customer organizations identified by an OrgID unique to the one respective customer organization;
determining the data resides within an external cloud platform;
performing an account multiplexer operation to identify multiple accounts at the external cloud platform based on both (i) a known association between OrgID and the multiple accounts at the external cloud platform and (ii) availability of known access credentials for the multiple accounts at the external cloud platform being accessible to the one customer organization identified by the OrgID;
breaking up the query into multiple sub-queries, each targeting a distinct one of the multiple accounts at the external cloud platform;
issuing the multiple sub-queries to the external cloud platform using the known access credentials for the multiple accounts;
receiving multiple data sets responsive to the multiple sub-queries issued to the external cloud platform;
aggregating the multiple data sets into an aggregated master data set in fulfillment of the query received; and
storing the aggregated master data set temporarily within the multi-tenant database system of the host organization.

2. The computer-implemented method of claim 1, wherein determining the data resides within the external cloud platform comprises determining that an authoritative master copy of the data is persisted by an external data repository at the external cloud platform.

3. The computer-implemented method of claim 1, wherein the method further comprises:
exposing a queryable virtual object within the host organization;
wherein the queryable virtual object is accessible via native queries to functions, services, and applications executing within the host organization on behalf of the plurality of customer organizations;
wherein the queryable virtual object persists no data on behalf of any of the plurality of customer organizations; and
wherein determining the data resides within the external cloud platform is based at least in part on the query targeting the queryable virtual object which is pre-configured to responsively retrieve data from the external cloud platform upon receiving any query.

4. The computer-implemented method of claim 1, wherein the method further comprises:
exposing a queryable virtual object within the host organization pre-configured to retrieve data from the external cloud platform responsive to being specified as the target of a database query;
responsively retrieving the data from the external cloud platform and storing the aggregated master data set temporarily within the multi-tenant database system of the host organization; and
accessing the aggregated master data set locally from the multi-tenant database system of the host organization in fulfillment of the query received.

5. The computer-implemented method of claim 1, wherein receiving the query at the host organization comprises:
receiving an asynchronous query from an analytics engine of the host organization on behalf of the one customer organization identified by the OrgID; and
determining the asynchronous query requires data retrieval from the external cloud platform;
transmitting the asynchronous query to an off-stack batch processor located at the external cloud platform; and
wherein the computer-implemented method further comprises:
(i) repeatedly accessing the aggregated master data set temporarily stored within the multi-tenant database system in fulfillment of a plurality of queries from the analytics engine; and
(ii) purging the aggregated master data set temporarily stored within the multi-tenant database system rendering the aggregated master data set inaccessible from the host organization without a new data retrieval operation from the external cloud platform.

6. The computer-implemented method of claim 1, wherein determining the data resides within an external cloud platform comprises one of:
receiving the query having query parameters encoded therein targeting a queryable virtual object pre-configured to retrieve the data from the external cloud platform;
receiving the query having an object or table name specified therein corresponding to the queryable virtual object; and
receiving the query having a custom data type pre-determined to correspond to data accessible from the external cloud platform and inaccessible from within the host organization without issuing external queries to the external cloud platform.

7. The computer-implemented method of claim 1, wherein performing an account multiplexer operation to identify multiple accounts at the external cloud platform, comprises:
transmitting the OrgID uniquely identifying the one customer organization from the host organization to the external cloud platform, wherein the external cloud platform responsively performs an account lookup to identify the multiple accounts at the external cloud platform known to be associated with the one customer organization based on the OrgID transmitted; and
receiving external account identifiers from the external cloud platform for each of the multiple accounts at the external cloud platform known to be associated with the one customer organization;
retrieving foreign authentication credentials from within the host organization via a query to the multi-tenant database system of the host organization utilizing the OrgID and the access authority of the OrgID; and
transmitting the foreign authentication credentials for the external account identifiers to the external cloud platform to gain access to the data specified by the query which is hosted by the external cloud platform.

8. The computer-implemented method of claim 1, wherein performing an account multiplexer operation to identify multiple accounts at the external cloud platform, comprises:
performing an account lookup at the host organization utilizing the OrgID to identify external account identifiers for the multiple accounts at the external cloud platform known to be associated with the one customer organization uniquely identified by the OrgID; and
retrieving foreign authentication credentials from within the host organization for each of the external account identifiers; and
wherein issuing the multiple sub-queries to the external cloud platform using the known access credentials for the multiple accounts comprises transmitting the foreign authentication credentials with the multiple sub-queries to the external cloud platform.

9. The computer-implemented method of claim 1:
wherein the query received comprises an asynchronous query received at a high-throughput job processor of the host organization; and
wherein the computer-implemented method further comprises:
intercepting the asynchronous query received via an off-stack chunking interceptor;
bypassing processing of the intercepted asynchronous query at the host organization and re-routing the intercepted asynchronous query for processing via the external cloud platform over a link to an external data repository of the external cloud platform; and
polling the external data repository repeatedly for completion status of the processing of the asynchronous query; and
consuming all results received at the host organization from the external data repository in fulfillment of processing the asynchronous query at the external cloud platform.

10. The computer-implemented method of claim 1, wherein breaking up the query into multiple sub-queries, further comprises:
instructing the external cloud platform to process the multiple sub-queries in parallel.

11. The computer-implemented method of claim 1, further comprising:
determining the query received is an asynchronous query;
chunking the asynchronous query into multiple parts on the basis of a common primary key shared by all of the multiple parts, each capable of executing in parallel at the external cloud platform; and
transmitting the multiple parts of the asynchronous query to the external cloud platform for parallel processing.

12. The computer-implemented method of claim 1, wherein breaking up the query into multiple sub-queries, each targeting a distinct one of the multiple accounts at the external cloud platform, further comprises:
fragmenting at least one of the multiple sub-queries for one of the multiple accounts into additional query sub-parts utilizing a common primary key shared by all of the additional query sub-parts; and
instructing the external cloud platform to execute the additional query sub-parts using parallel processing.

13. The computer-implemented method of claim 1, further comprising:
determining the query received is an asynchronous query;
transmitting the asynchronous query to the external cloud platform with a request for parallel processing; and
wherein the external cloud platform responsively chunks the asynchronous query into multiple parts on the basis of a common primary key shared by all of the multiple parts and subjecting each of the multiple parts to parallel processing at the external cloud platform.

14. The computer-implemented method of claim 1, wherein aggregating the multiple data sets into the aggregated master data set in fulfillment of the query received comprises:
collecting each of the multiple data sets returned from the external cloud platform;
iteratively polling the external cloud platform for completion status of the multiple sub-queries issued to the external cloud platform; and
aggregating the multiple data sets at the host organization into the aggregated master data set utilizing a common primary key shared by all of the multiple data sets.

15. Non-transitory computer readable storage media having instructions stored thereupon that, when executed by a host organization having at least a processor and a memory therein, the instructions cause the processor to perform operations comprising:
interfacing with a multi-tenant database system of the host organization having information stored on behalf of a plurality of customer organizations;
receiving a query at the host organization requesting retrieval of data stored on behalf of one of the plurality of customer organizations identified by an OrgID unique to the one respective customer organization;
determining the data resides within an external cloud platform;
performing an account multiplexer operation to identify multiple accounts at the external cloud platform based on both (i) a known association between OrgID and the multiple accounts at the external cloud platform and (ii) availability of known access credentials for the multiple accounts at the external cloud platform being accessible to the one customer organization identified by the OrgID;
breaking up the query into multiple sub-queries, each targeting a distinct one of the multiple accounts at the external cloud platform;
issuing the multiple sub-queries to the external cloud platform using the known access credentials for the multiple accounts;
receiving multiple data sets responsive to the multiple sub-queries issued to the external cloud platform;
aggregating the multiple data sets into an aggregated master data set in fulfillment of the query received; and
storing the aggregated master data set temporarily within the multi-tenant database system of the host organization.

16. The non-transitory computer readable storage media of claim 15, wherein determining the data resides within the external cloud platform comprises determining that an authoritative master copy of the data is persisted by an external data repository at the external cloud platform.

17. The non-transitory computer readable storage media of claim 15, wherein the instructions, when executed, cause the processor to perform operations further comprising:
exposing a queryable virtual object within the host organization;
wherein the queryable virtual object is accessible via native queries to functions, services, and applications executing within the host organization on behalf of the plurality of customer organizations;
wherein the queryable virtual object persists no data on behalf of any of the plurality of customer organizations; and
wherein determining the data resides within the external cloud platform is based at least in part on the query targeting the queryable virtual object which is pre-configured to responsively retrieve data from the external cloud platform upon receiving any query.

18. The non-transitory computer readable storage media of claim 15, wherein the instructions, when executed, cause the processor to perform operations further comprising:
determining the query received is an asynchronous query;
chunking the asynchronous query into multiple parts on the basis of a common primary key shared by all of the multiple parts, each capable of executing in parallel at the external cloud platform; and
transmitting the multiple parts of the asynchronous query to the external cloud platform for parallel processing.

19. A system to execute at a host organization, wherein the system comprises:
a memory to store instructions;
a set of one or more processors;
a non-transitory machine-readable storage medium that provides instructions that, when executed by the set of one or more processors, the instructions stored in the memory are configurable to cause the system to perform operations comprising:
executing instructions via the processor configurable to cause the system to operate an interface to a multi-tenant database system within the host organization having information stored on behalf of a plurality of customer organizations;
executing instructions via the processor configurable to cause the system to operate a receive interface to receive queries at the host organization;
receiving a query at the host organization requesting retrieval of data stored on behalf of one of the plurality of customer organizations identified by an OrgID unique to the one respective customer organization;
determining the data resides within an external cloud platform;
performing an account multiplexer operation to identify multiple accounts at the external cloud platform based on both (i) a known association between OrgID and the multiple accounts at the external cloud platform and (ii) availability of known access credentials for the multiple accounts at the external cloud platform being accessible to the one customer organization identified by the OrgID;
breaking up the query into multiple sub-queries, each targeting a distinct one of the multiple accounts at the external cloud platform;
issuing the multiple sub-queries to the external cloud platform using the known access credentials for the multiple accounts;
receiving multiple data sets responsive to the multiple sub-queries issued to the external cloud platform;
aggregating the multiple data sets into an aggregated master data set in fulfillment of the query received; and
storing the aggregated master data set temporarily within the multi-tenant database system of the host organization.

20. The system of claim 19, wherein the system implements a cloud computing platform to provide on-demand cloud based computing services to subscribers of the cloud computing platform; and
wherein end users of the cloud computing platform are each associated with one of the plurality of customer organizations having subscriber access to the on-demand cloud based computing services provided by the cloud computing platform.
